(19) United States
(12) Patent Application Publication
(10) Pub. No.: US 2026/0225767 A1
(43) Pub. Date: Aug. 6, 2026

(54) Cooking and Home Food Preservation Implement Storage Assembly

(71) Applicant: Jennifer Baker, South Fork, CO (US)

(72) Inventor: Jennifer Baker, South Fork, CO (US)

(21) Appl. No.: 19/043,592

(22) Filed: Feb. 3, 2025

(51) Int. Cl. B65D 25/06; B65D 21/02; B65D 25/32; B65D 43/16; B65D 43/22

(52) U.S. Cl. CPC B65D 25/06; B65D 21/0212; B65D 25/32; B65D 43/163; B65D 43/22

(57) ABSTRACT

The invention listed herein relates to a portable, stackable storage container assembly for the storage, organization and sanitary containment of implements used for cooking and Home Food Preservation methods such as pressure canning, water bath canning, fermenting, pickling, salting, dehydrating, freezing, vacuum sealing and all other forms of cooking and Home Food Preservation methods. In one embodiment of the invention, the apparatus may consist of multiple storage containers. The storage containers may each be used as an individual storage container or assembled as one stackable unit as the user desires for the convenience of storage, organization, easy portability and sanitary containment of cooking and Home Food Preservation implements.

This application claims priority to U.S. patent application 63/549,470 filed on Feb. 3, 2024.

### FIELD OF THE INVENTION

The various aspects discussed herein relate to storage, organization and sanitary containment of cooking and Home Food Preservation implements.

### BACKGROUND OF THE INVENTION

Cooking and Home Food Preservation implements used for; pressure canning, water bath canning, fermenting, pickling, salting, dehydrating, freezing, vacuum sealing or any other form of cooking and Home Food Preservation method are stored in diverse methods which may include; clothing hangers, plastic totes, plastic snap containers, plastic bags, ropes, twine, cords, piping, repurposed boxes, paper towel holders, stands, racks, open shelving, shower caddies, repurposed plastic containers, crates, floors, pots, drawers, cupboards, or pantries. Cooking and Home Food Preservation implements stored in these ways consume a substantial amount of space and results in cooking and Home Food Preservation implements becoming misplaced, damaged, rusted and often times, unsanitary. Storage for cooking and Home Food Preservation implements would be optimized by storage containers specific to cooking and Home Food Preservation implements.

Accordingly, there is a need in the art for improved storage containers for cooking and Home Food Preservation implements, which solves the problems listed above.

### BRIEF SUMMARY OF THE INVENTION

In one embodiment of the invention an apparatus system of portable storage assembly for storing and organizing cooking and Home Food Preservation implements is provided, the storage containers comprising a plurality of bases in connection with exterior sidewalls and top rims of the containers, joined by lids and may include locks, lock latch lower attachments affixed on or in a sidewall or, on or in the top rim, for the connection of a plurality of lock latch upper attachments affixed to the sidewalls, for securing the lids in a locked position by the lock latch lower attachments.

In one embodiment of the invention the apparatus may include a plurality of handles affixed to a plurality of sidewalls, wherein said handles are affixed to the top rims or base of the storage containers or to a plurality of sidewalls by a handle pivot hinge or a plurality of handle pivot hinges on each side of the handle end points, allowing the handle to move in multiple directions.

In one embodiment of the invention the apparatus may include locking mechanisms outer attachments, which may be located on a plurality of sidewalls wherein locking mechanisms inner attachments are connected with the locking mechanisms outer attachments to create locking points for connection and stacking of multiple storage containers and may include lock latch upper attachments and lock latch lower attachments for securing the lids in a locked position.

In one embodiment of the invention the assembly may include a plurality of interior sidewalls creating the interior compartments of storage containers wherein contains interior bases, located inside the storage containers which may accommodate, a plurality of permanent or demountable divider guides inside the storage containers for possible location placement of storage compartments for smaller storage containers along with cooking and Home Food Preservation implements which may include but are not limited to; cooking, pressure canning, water bath canning, fermenting, pickling, salting, dehydrating, freezing, vacuum sealing or any other form of cooking and Home Food Preservation method implements.

### BRIEF DESCRIPTION OF THE DRAWINGS

FIG. 1A is a front view of cooking and Home Food Preservation

multipurpose or miscellaneous implement storage container;

FIG. 1B is a back view of cooking and Home Food Preservation multipurpose or miscellaneous implement storage container;

FIG. 1C is a top view of cooking and Home Food Preservation multipurpose or miscellaneous implement storage container;

FIG. 1D is a bottom view of cooking and Home Food Preservation multipurpose or miscellaneous implement storage container;

FIG. 1E is a left view of cooking and Home Food Preservation multipurpose or miscellaneous implement storage container;

FIG. 1F is a right view of cooking and Home Food Preservation multipurpose or miscellaneous implement storage container;

FIG. 1G is a front view of handle extended on cooking and Home Food Preservation multipurpose or miscellaneous implement storage container;

FIG. 1H is a top view of lid open on cooking and Home Food Preservation multipurpose or miscellaneous implement storage container;

FIG. 1I is an exploded view of cooking and Home Food Preservation multipurpose or miscellaneous implement storage container;

FIG. 1J is a front Xray view of FIG. 1A cooking and Home Food Preservation multipurpose or miscellaneous implement storage container;

FIG. 2A is a front view of cooking and Home Food Preservation fermenting or miscellaneous implement storage container;

FIG. 2B is a back view of cooking and Home Food Preservation fermenting or miscellaneous implement storage container;

FIG. 2C is a top view of cooking and Home Food Preservation fermenting or miscellaneous implement storage container;

FIG. 2D is a bottom view of cooking and Home Food Preservation fermenting or miscellaneous implement storage container;

FIG. 2E is a left view of cooking and Home Food Preservation fermenting or miscellaneous implement storage container;

FIG. 2F is a right view of cooking and Home Food Preservation fermenting or miscellaneous implement storage container;

FIG. 2G is a front view of handle extended on cooking and Home Food Preservation fermenting or miscellaneous implement storage container;

FIG. 2H is a top view of lid open on cooking and Home Food Preservation fermenting or miscellaneous implement storage container;

FIG. 2I is an exploded view of cooking and Home Food Preservation fermenting or miscellaneous implement storage container;

FIG. 2J is a front Xray view of FIG. 2A cooking and Home Food Preservation fermenting or miscellaneous implement storage container;

FIG. 2K is a front view of cooking and Home Food Preservation fermenting lids or miscellaneous implement storage container with images of lid open and lid closed;

FIG. 2L is a back view of cooking and Home Food Preservation fermenting lids or miscellaneous implement storage container with images of lid open and lid closed;

FIG. 2M is a front view of cooking and Home Food Preservation fermenting glass/ceramic weights/pebbles or miscellaneous implement storage container with images of lid open and lid closed;

FIG. 2N is a back view of cooking and Home Food Preservation fermenting glass/ceramic weights/pebbles or miscellaneous implement storage container with images of lid open and lid closed;

FIG. 3A is a front view of cooking and Home Food Preservation lids or miscellaneous implement storage container;

FIG. 3B is a back view of cooking and Home Food Preservation lids or miscellaneous implement storage container;

FIG. 3C is a top view of cooking and Home Food Preservation lids or miscellaneous implement storage container;

FIG. 3D is a bottom view of cooking and Home Food Preservation lids or miscellaneous implement storage container;

FIG. 3E is a left view of cooking and Home Food Preservation lids or miscellaneous implement storage container;

FIG. 3F is a right view of cooking and Home Food Preservation lids or miscellaneous implement storage container;

FIG. 3G is a front view of handle extended on cooking and Home Food Preservation lids or miscellaneous implement storage container;

FIG. 3H is a top view of lid open on cooking and Home Food Preservation lids or miscellaneous implement storage container;

FIG. 3I is an exploded view of cooking and Home Food Preservation lids or miscellaneous implement storage container;

FIG. 3J is a front Xray view of FIG. 3A cooking and Home Food Preservation lids or miscellaneous implement storage container;

FIG. 3K is a front view of cooking and Home Food Preservation reusable plastic/glass lids or miscellaneous implement storage container with images of lid open and lid closed;

FIG. 3L is a back view of cooking and Home Food Preservation reusable plastic/glass lids or miscellaneous implement storage container with images of lid open and lid closed;

FIG. 3M is a front view of cooking and Home Food Preservation disposable metal lids or miscellaneous implement storage container with images of lid open and lid closed;

FIG. 3N is a back view of cooking and Home Food Preservation disposable metal lids or miscellaneous implement storage container with images of lid open and lid closed;

FIG. 4A is a front view of cooking and Home Food Preservation canning ring band or miscellaneous implement storage container;

FIG. 4B is a back view of cooking and Home Food Preservation canning ring band or miscellaneous implement storage container;

FIG. 4C is a top view of cooking and Home Food Preservation canning ring band or miscellaneous implement storage container;

FIG. 4D is a bottom view of cooking and Home Food Preservation canning ring band or miscellaneous implement storage container;

FIG. 4E is a left view of cooking and Home Food Preservation canning ring band or miscellaneous implement storage container;

FIG. 4F is a right view of cooking and Home Food Preservation canning ring band or miscellaneous implement storage container;

FIG. 4G is a front view of handle extended on cooking and Home Food Preservation canning ring band or miscellaneous implement storage container;

FIG. 4H is a top view of lid open on cooking and Home Food Preservation canning ring band or miscellaneous implement storage container;

FIG. 4I is an exploded view of cooking and Home Food Preservation canning ring band or miscellaneous implement storage container;

FIG. 4J is front Xray view of FIG. 4A cooking and Home Food Preservation canning ring band or miscellaneous implement storage container;

FIG. 4K is a front view of lower compartments for cooking and Home Food Preservation canning ring band, reusable plastic/glass lids, rubber/silicone gaskets/rings implement storage container with images of lid open and lid closed;

FIG. 4L is a back view of lower compartments for cooking and Home Food Preservation canning ring band, reusable plastic/glass lids, rubber/silicone gaskets/rings implement storage container with images of lid open and lid closed;

FIG. 4M is a front view of upper compartments for cooking and Home Food Preservation canning ring band, reusable plastic/glass lids, rubber/silicone gaskets/rings implement storage container with images of lid open and lid closed;

FIG. 4N is a back view of upper compartments for cooking and Home Food Preservation canning ring band, reusable plastic/glass lids, rubber/silicone gaskets/rings implement storage container with images of lid open and lid closed;

FIG. 4O is a front view of 10 cooking and Home Food Preservation canning ring band, reusable plastic/glass lids, rubber/silicone gaskets/rings implement storage container to fit inside FIG. 4A;

FIG. 4P is a front view of possible placement of FIG. 4O inside FIG. 4I;

FIG. 5A is a front view of cooking and Home Food Preservation jar/mason jar or miscellaneous implement storage container;

FIG. 5B is a top view of cooking and Home Food Preservation jar/mason jar or miscellaneous implement storage container with lid off;

FIG. 5C is an exploded view of cooking and Home Food Preservation jar/mason jar or miscellaneous implement storage container;

FIG. 5D is a view of cooking and Home Food Preservation jar/mason jar or miscellaneous implement storage container base frame with 2 of 4 pivoting/collapsable structural frame corners partially extended and 2 of 4 pivoting/collapsable structural frame corners folded into the frame;

FIG. 5E is a view of cooking and Home Food Preservation jar/mason jar or miscellaneous implement storage container lid and locking rim of container;

FIG. 5F is a view of permanent or demountable exterior sidewalls and dividers for cooking and Home Food Preservation jar/mason jar or miscellaneous implement storage container;

FIG. 5G is a view of cooking and Home Food Preservation jar/mason jar or miscellaneous implement storage container collapsed and locked together with all permanent or demountable exterior sidewalls and dividers of cooking and Home Food Preservation jar/mason jar or miscellaneous implement storage container fitted inside;

FIG. 6A is a front view of cooking and Home Food Preservation implement storage containers assembled as one unit;

FIG. 6B is a back view of cooking and Home Food Preservation implement storage containers assembled as one unit with handle extended;

FIG. 6C is a top view of cooking and Home Food Preservation implement storage containers assembled as one unit;

FIG. 6D is a bottom view of cooking and Home Food Preservation implement storage containers assembled as one unit;

FIG. 6E is a left view of cooking and Home Food Preservation implement storage containers assembled as one unit;

FIG. 6F is a right view of cooking and Home Food Preservation implement storage containers assembled as one unit;

FIG. 6G is an exploded view of cooking and Home Food Preservation implement storage containers;

FIG. 6H is a front Xray view of FIG. 5A cooking and Home Food Preservation implement storage containers assembled as one unit.

### DETAILED DESCRIPTION OF THE INVENTION

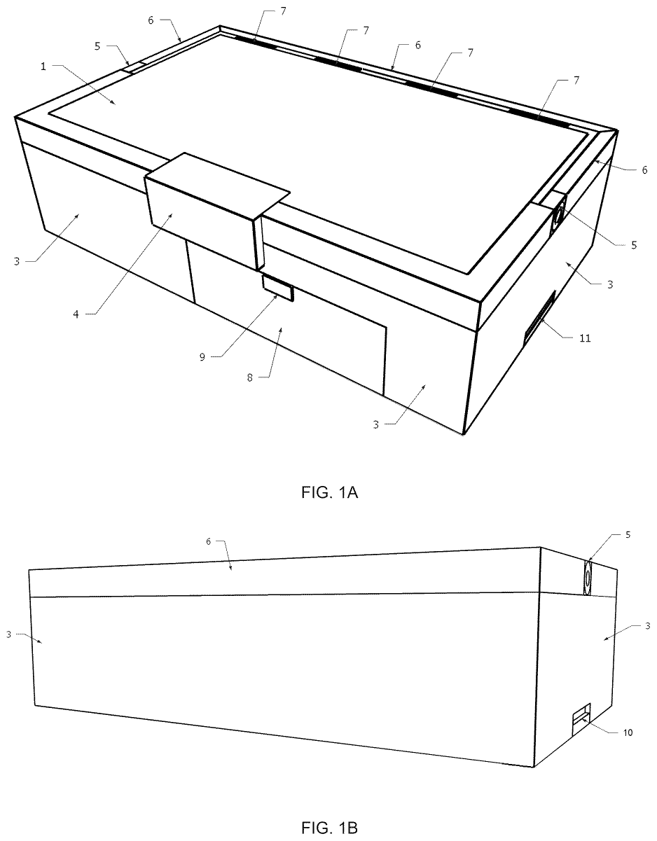

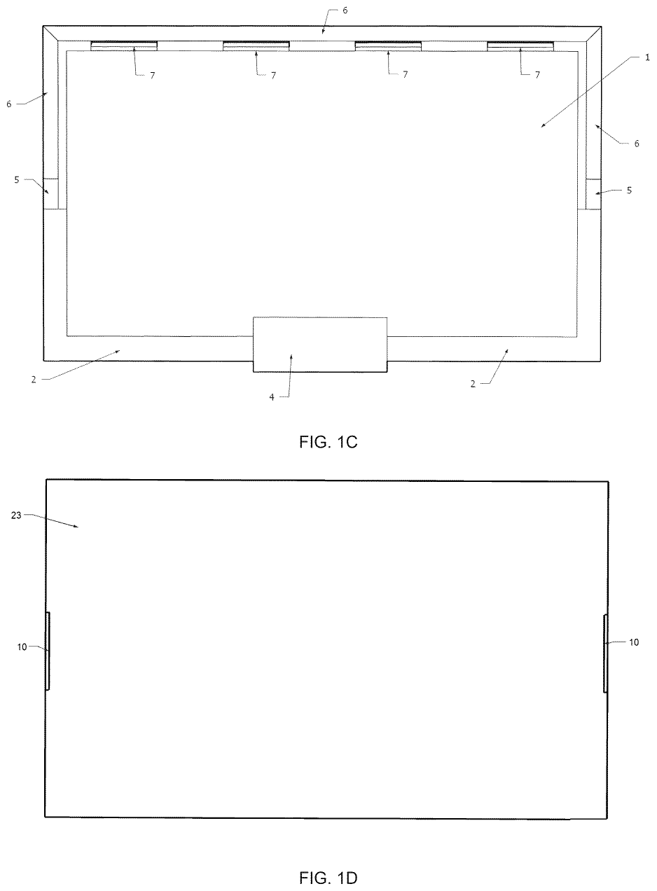

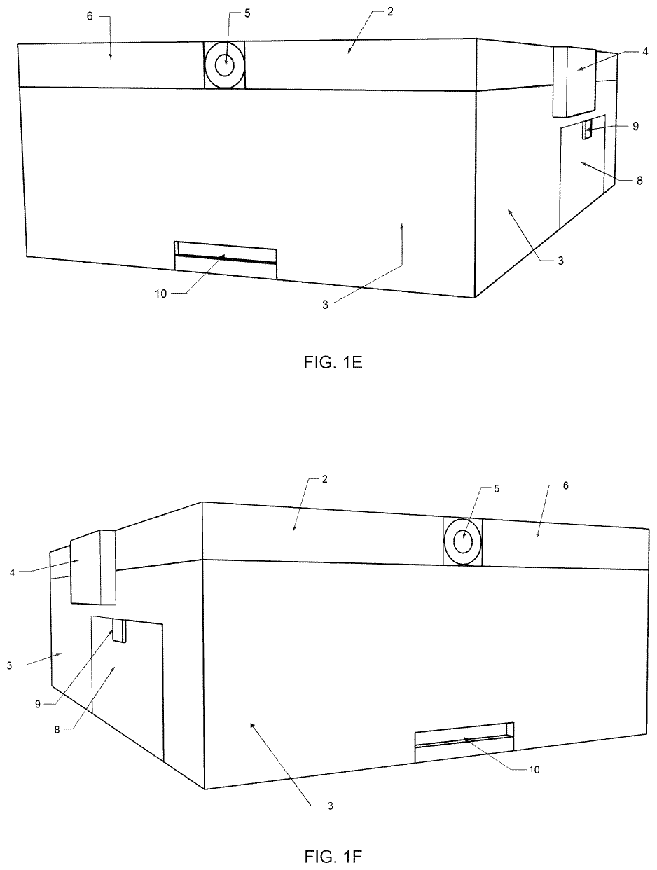

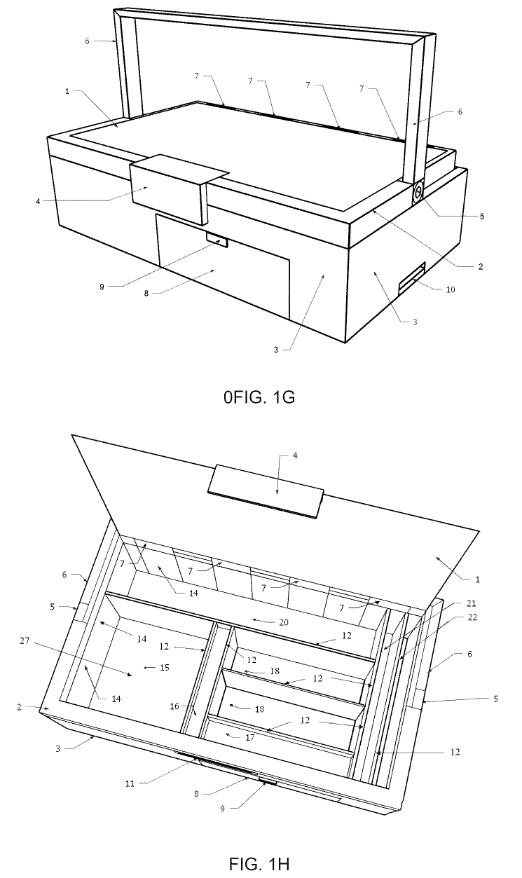

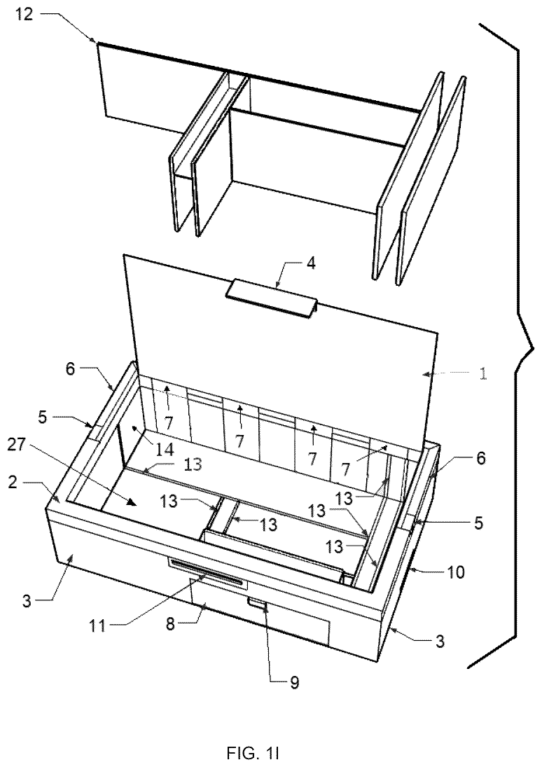

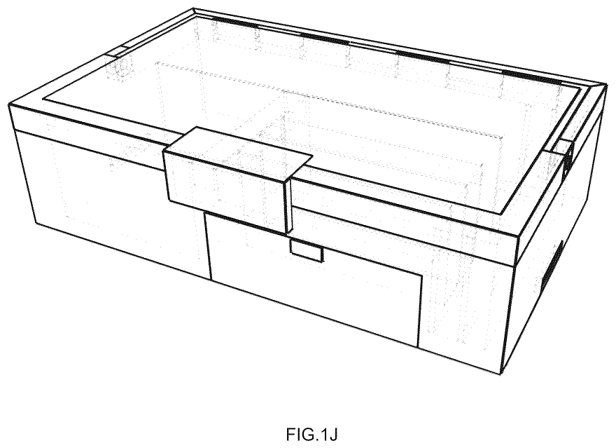

FIG. 1A shows one embodiment of the present invention of a front view of cooking and Home Food Preservation multipurpose or miscellaneous implement storage container. In this particular embodiment of the present invention, cooking and Home Food Preservation multipurpose or miscellaneous implement storage container is shown with a lid 1, a plurality of exterior sidewalls 3 (three not shown), pullout drawer 8, a button lock 9 for pullout drawer 8, a lock latch upper attachment 4, a top rim 2, a plurality of handle pivot hinges 5, a handle 6, and a plurality of hinges 7, according to one embodiment of the present invention.

FIG. 1B shows one embodiment of the present invention of a back view of cooking and Home Food Preservation multipurpose or miscellaneous implement storage container. In this particular embodiment of the present invention, cooking and Home Food Preservation multipurpose or miscellaneous implement storage container is shown with a plurality of exterior sidewalls 3 (two not shown), handle pivot hinges 5 (one not shown), handle 6, and a plurality of locking mechanism inner attachments (one not shown) 10, according to one embodiment of the present invention.

FIG. 1C shows one embodiment of the present invention of a top view of cooking and Home Food Preservation multipurpose or miscellaneous implement storage container. In this particular embodiment of the present invention cooking and Home Food Preservation multipurpose or miscellaneous implement storage container is shown with a lid 1, a top rim 2, a plurality of handle pivot hinges 5, a handle 6, a plurality of hinges 7, and a lock latch upper attachment 4, according to one embodiment of the present invention.

FIG. 1D shows one embodiment of the present invention of a bottom view of cooking and Home Food Preservation multipurpose or miscellaneous implement storage container. In this particular embodiment of the present invention, cooking and Home Food Preservation multipurpose or miscellaneous implement storage container is shown with a base of storage container 23, a plurality of locking mechanisms inner attachments 10, according to one embodiment of the present invention.

FIG. 1E shows one embodiment of the present invention of a left view of cooking and Home Food Preservation multipurpose or miscellaneous implement storage container. In this particular embodiment of the present invention, cooking and Home Food Preservation multipurpose or miscellaneous implement storage container is shown with a plurality of exterior sidewalls 3 (two not shown), pullout drawer 8, a button lock 9 for pullout drawer 8, a lock latch upper attachment 4, a top rim 2, a plurality of handle pivot hinges 5 (one not shown), a handle 6, and a plurality of locking mechanism inner attachments 10 (one not shown), according to one embodiment of the present invention.

FIG. 1F shows one embodiment of the present invention of a right view of cooking and Home Food Preservation multipurpose or miscellaneous implement storage container. In this particular embodiment of the present invention, cooking and Home Food Preservation multipurpose or miscellaneous implement storage container is shown with a plurality of exterior sidewalls 3 (two not shown), pullout drawer 8, a button lock 9 for pullout drawer, a lock latch upper attachment 4, a top rim 2, a plurality of handle pivot hinges 5, a handle 6, locking mechanism inner attachments 10 (one not shown), according to one embodiment of the present invention.

FIG. 1G shows one embodiment of the present invention of a front view of handle extended on cooking and Home Food Preservation multipurpose or miscellaneous implement storage container. In this particular embodiment of the present invention, cooking and Home Food Preservation multipurpose or miscellaneous implement storage container is shown with a lid 1, a plurality of exterior sidewalls 3 (two not shown), pullout drawer 8, a button lock 9 for pullout drawer 8, a lock latch upper attachments 4, a top rim 2, a plurality of handle pivot hinges 5 (one not shown), a handle 6, and a plurality of hinges 7, and a plurality of locking mechanism inner attachments 10 (one not shown), according to one embodiment of the present invention.

FIG. 1H shows one embodiment of the present invention of a top view of lid open on cooking and Home Food Preservation multipurpose or miscellaneous implement storage container. In this particular embodiment of the invention, the cooking and Home Food Preservation multipurpose or miscellaneous implement storage container is shown with permanent or demountable dividers 12 inside the storage container. The dividers may be configured inside the storage container in various possible locations as well as demounted to create a larger storage compartment according to the user's need and preferences. The dividers 12, create compartments for multipurpose or miscellaneous implements used in cooking and Home Food Preservation methods such as; pressure canning, water bath canning, fermenting, pickling, salting, dehydrating, freezing and vacuum sealing. Storage compartments may include; a funnels storage compartment 15, a magnet wands storage compartment 16, a de-bubblers storage compartment 17, one or more jar lifters/tongs storage compartments 18, a kitchen tongs/miscellaneous implement storage compartment 20, a corn kernel remover tool storage compartment 21 as well as a jar wrenches storage compartment 22. The storage container may consist of an interior base 27, a plurality of exterior sidewalls 3 (three not shown), interior sidewalls 14, a top rim 2, a handle 6, handle pivot hinges 5, a lid 1, a lock latch upper attachments 4, a lock latch lower attachments 11, a hinge or plurality of hinges 7, drawer guides 19 (not shown), a pullout drawer 8, and a button lock 9 for pullout drawer 8, according to an embodiment of the present invention.

FIG. 1I shows one embodiment of the present invention of an exploded view of FIG. 1A cooking and Home Food Preservation multipurpose or miscellaneous implement storage container. In this particular embodiment of the present invention, cooking and Home Food Preservation multipurpose or miscellaneous implement storage container is shown with permanent or demountable dividers 12 demounted above the storage container, creating an optional larger storage compartment for the user's needs and preferences. This embodiment of the present invention is shown with a lid 1, a plurality of exterior sidewalls 3 (two not shown), a lock latch upper attachments 4, a top rim 2, a plurality of handle pivot hinges 5, a handle 6, and a plurality of hinges 7, divider guides 13, a plurality of sidewalls 14, and interior base of storage container 27, a lock latch lower attachment 11, drawer guides 19 (not shown), a pullout drawer 8, and a button lock 9, for pullout drawer a plurality of locking mechanism attachments 10 (one not shown), according to one embodiment of the present invention.

FIG. 1J shows one embodiment of the present invention of a front Xray view of FIG. 1A cooking and Home Food Preservation multipurpose or miscellaneous implement storage container. In this particular embodiment of the present invention, cooking and Home Food Preservation multipurpose or miscellaneous implement storage container is shown as a front Xray view, according to one embodiment of the present invention.

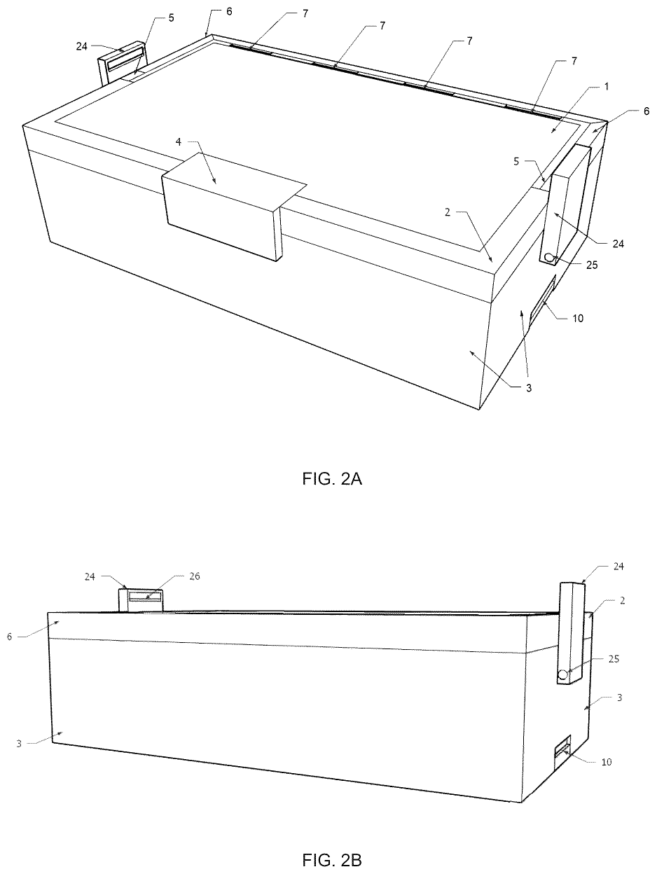

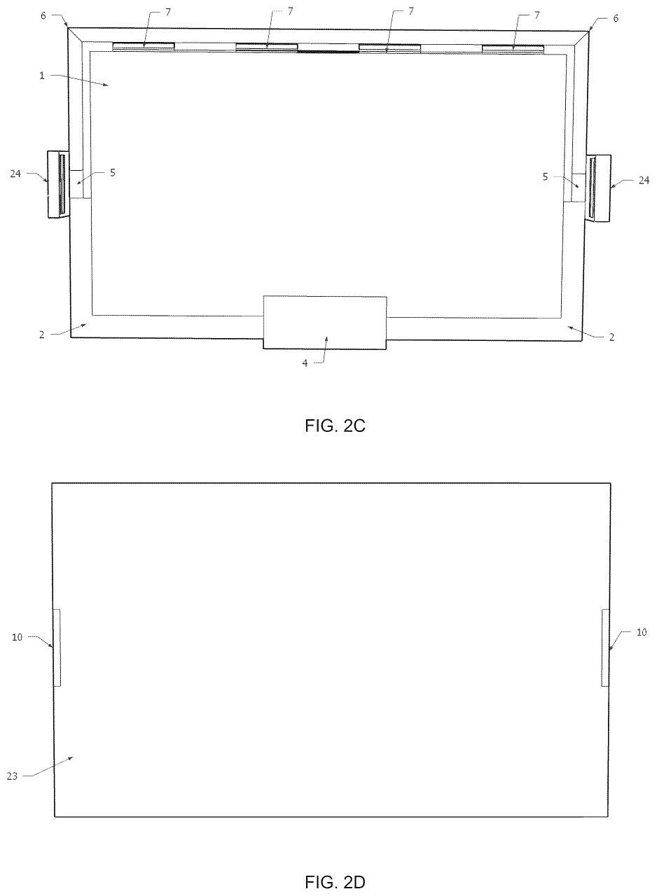

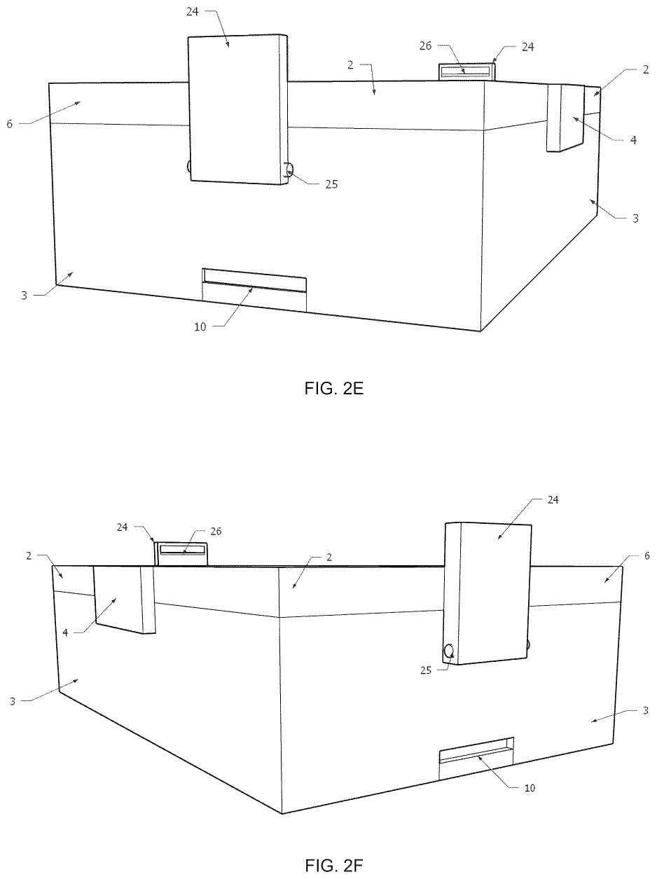

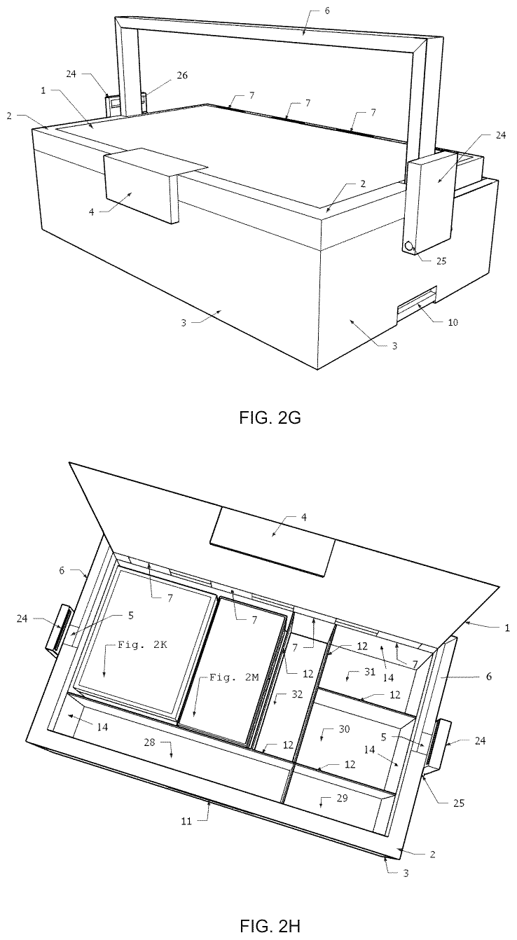

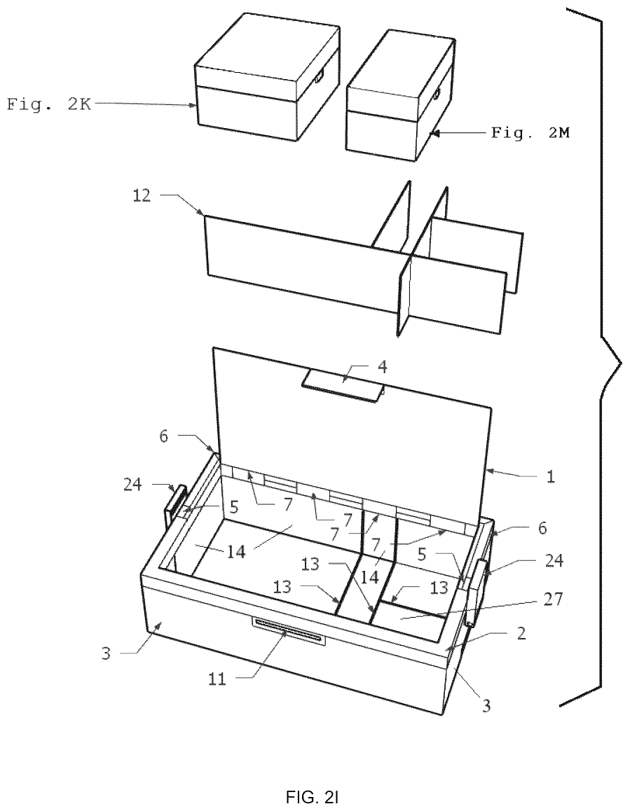

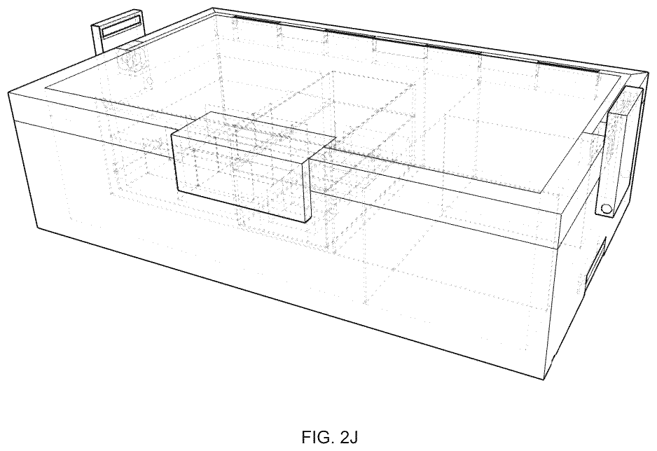

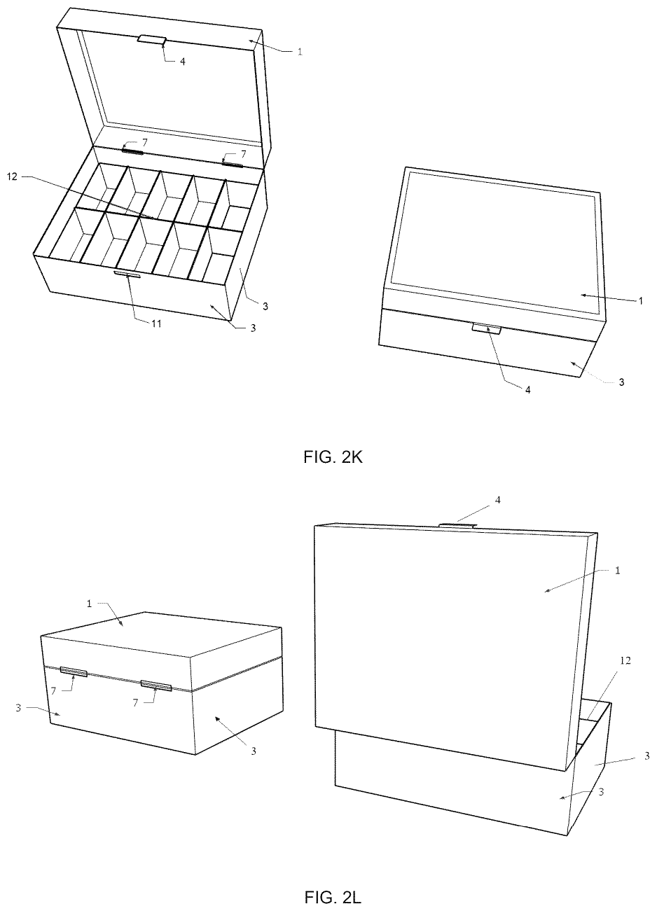

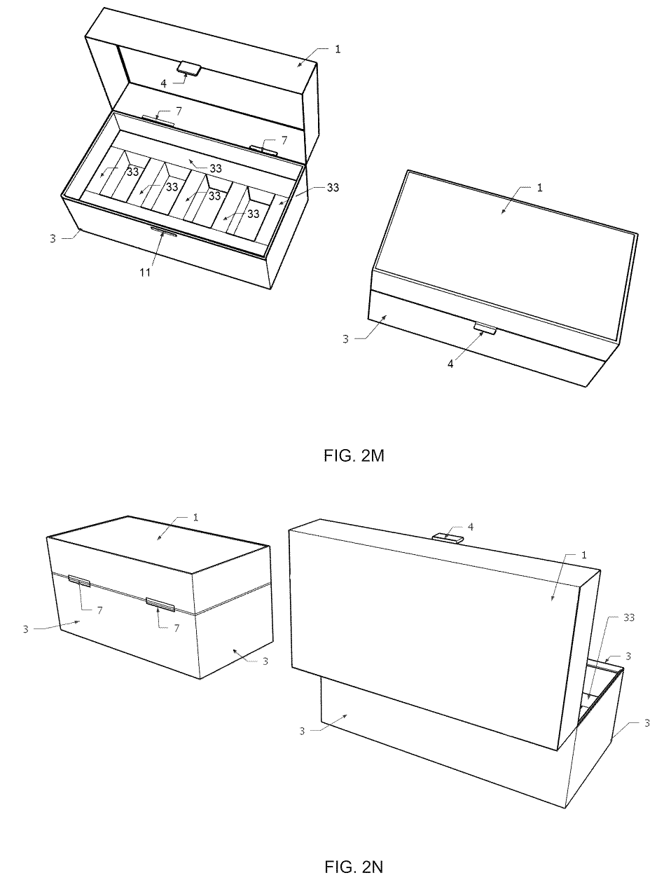

FIG. 2A shows one embodiment of the present invention of a front view of cooking and Home Food Preservation fermenting or miscellaneous implement storage container. In this particular embodiment of the present invention, cooking and Home Food Preservation fermenting or miscellaneous implement storage container is shown with a lid 1, a plurality of exterior sidewalls 3 (two not shown), a lock latch upper attachment 4, a top rim 2, a plurality of handle pivot hinges 5, a handle 6, and a plurality of hinges 7, a plurality of locking mechanism outer attachments 24 (one not shown), a plurality of locking mechanism hinges 25 (one not shown), a plurality of locking mechanism inner attachments 10 (one not shown), according to one embodiment of the present invention.

FIG. 2B shows one embodiment of the present invention of a back view of cooking and Home Food Preservation fermenting or miscellaneous implement storage container. In this particular embodiment of the present invention, cooking and Home Food Preservation fermenting or miscellaneous implement storage container is shown a plurality of exterior sidewalls 3 (two not shown), a top rim 2, a plurality of locking mechanism outer attachments 24 (one not shown), a plurality of locking mechanism hinges 25 (only one shown), a plurality of locking mechanism inner attachments 26 (one not shown), a plurality of locking mechanism inner attachments 10 (one not shown), according to one embodiment of the present invention.

FIG. 2C shows one embodiment of the present invention of a top view of cooking and Home Food Preservation fermenting or miscellaneous implement storage container. In this particular embodiment of the present invention, cooking and Home Food Preservation fermenting or miscellaneous implement storage container is shown with a lid 1, a lock latch upper attachment 4, a top rim 2, a plurality of handle pivot hinges 5, a handle 6, and a plurality of hinges 7, a plurality of locking mechanism outer attachments 24, according to one embodiment of the present invention.

FIG. 2D shows one embodiment of the present invention of a bottom view of cooking and Home Food Preservation fermenting or miscellaneous implement storage container. In this particular embodiment of the present invention, cooking and Home Food Preservation fermenting or miscellaneous implement storage container is shown with a base of storage container 23, a plurality of locking mechanism inner attachments 10, according to one embodiment of the present invention.

FIG. 2E shows one embodiment of the present invention of a left view of cooking and Home Food Preservation fermenting or miscellaneous implement storage container. In this particular embodiment of the present invention, cooking and Home Food Preservation fermenting or miscellaneous implement storage container is shown with a plurality of exterior sidewalls 3 (two not shown), a lock latch upper attachment 4, a top rim 2, a handle 6, a plurality of locking mechanism outer attachments 24 (one not shown), a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 2F shows one embodiment of the present invention of a right view of cooking and Home Food Preservation fermenting or miscellaneous implement storage container. In this particular embodiment of the present invention, cooking and Home Food Preservation fermenting or miscellaneous implement storage container is shown a plurality of exterior sidewalls 3 (two not shown), a lock latch upper attachment 4, a top rim 2, a plurality of handle pivot hinges 5, a handle 6, and a plurality of hinges 7, a plurality of locking mechanism outer attachments 24 (one not shown), a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 2G shows one embodiment of the present invention of a front view of handle extended on cooking and Home Food Preservation fermenting or miscellaneous implement storage container. In this particular embodiment of the present invention, cooking and Home Food Preservation fermenting or miscellaneous implement storage container is shown a lid 1, a plurality of exterior sidewalls 3 (two not shown), a lock latch upper attachment 4, a top rim 2, a handle 6, and a plurality of hinges 7, a plurality of locking mechanism outer attachments 24, a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 2H shows one embodiment of the present invention of a top view of lid open on cooking and Home Food Preservation fermenting or miscellaneous implement storage container. In this particular embodiment of the present invention, cooking and Home Food Preservation fermenting or miscellaneous implement storage container is shown with permanent or demountable dividers 12 inside the storage container. The dividers 12, may be configured inside the storage container in various possible locations as well as demounted to create a larger storage compartment according to the user's need and preferences. The dividers 12, create compartments for implements used in cooking and Home Food Preservation methods such as; fermenting, Pickling, Salting, Dehydrating, Freezing and Vacuum Sealing. These cooking and Home Food Preservation implements may include but are not limited to; food packers/wooden tamps storage compartment 28, an oxygen extraction pumps storage compartment 29, a silicone airlock lids storage compartment 30, a fermenting springs storage compartment 31, a fermenting exhaust valves storage compartment 32, permanent or demountable dividers 12, a plurality of exterior sidewalls 3 (three not shown), interior sidewalls 14, a lid 1, a lock latch upper attachment 4, a top rim 2, a plurality of handle pivot hinges 5, a handle 6, and a plurality of hinges 7, a plurality of locking mechanism outer attachments 24, a lock latch lower attachment 11, a plurality of locking mechanism hinges 25 (one not shown), FIG. 2K (cooking and Home Food Preservation fermenting lids or miscellaneous implement storage container), and FIG. 2M (cooking and Home Food Preservation fermenting glass/ceramic weights/pebbles or miscellaneous implement storage container), according to one embodiment of the present invention.

FIG. 2I shows one embodiment of the present invention of an exploded view of FIG. 2A cooking and Home Food Preservation fermenting or miscellaneous implement storage container. In this particular embodiment of the present invention, cooking and Home Food Preservation fermenting or miscellaneous implement storage container is shown with permanent or demountable dividers 12 demounted above the storage container, creating an optional larger storage compartment for the user's needs and preferences. This embodiment of the present invention is shown with a lid 1, a plurality of exterior sidewalls 3 (two not shown), a lock latch upper attachments 4, a top rim 2, a plurality of handle pivot hinges 5, a handle 6, and a plurality of hinges 7, divider guides 13, a plurality of sidewalls 14, and interior base of storage container 27, a lock latch lower attachment 11, a plurality of locking mechanism outer attachments 24, FIG. 2K (cooking and Home Food Preservation fermenting lids or miscellaneous implement storage container), and FIG. 2M (cooking and Home Food Preservation fermenting glass/ceramic weights/pebbles or miscellaneous implement storage container), according to one embodiment of the present invention.

FIG. 2J shows one embodiment of the present invention of a front Xray view of FIG. 2A cooking and Home Food Preservation fermenting or miscellaneous implement storage container. In this particular embodiment of the present invention, cooking and Home Food Preservation fermenting or miscellaneous implement storage container is shown as a front Xray view, according to one embodiment of the present invention.

FIG. 2K is a front view of cooking and Home Food Preservation fermenting lids or miscellaneous implement storage container. In this particular embodiment of the present invention, cooking and Home Food Preservation fermenting lids or miscellaneous implement storage container is shown with permanent or demountable dividers 12, lid 1, a plurality of exterior sidewalls 3 (five not shown), a lock latch upper attachment 4, a lock latch lower attachment 11, according to one embodiment of the present invention.

FIG. 2L is a back view of cooking and Home Food Preservation fermenting lids or miscellaneous implement storage container. In this particular embodiment of the present invention, cooking and Home Food Preservation fermenting lids or miscellaneous implement storage container is shown with permanent or demountable dividers 12, a lid 1, a plurality of exterior sidewalls 3 (four not shown), a lock latch upper attachment 4, a plurality of hinges 7, according to one embodiment of the present invention.

FIG. 2M is a front view of cooking and Home Food Preservation fermenting glass/ceramic weights/pebbles or miscellaneous implement storage container with images of lid open and lid closed. In this particular embodiment of the present invention, cooking and Home Food Preservation fermenting glass/ceramic weights/pebbles or miscellaneous implement storage container is shown with foam protectors for fermenting glass/ceramic weights/pebbles 33, lid 1, a plurality of exterior sidewalls 3 (five not shown), a lock latch upper attachment 4, a lock latch lower attachment 11, a plurality of hinges 7, according to one embodiment of the present invention.

FIG. 2N is a back view of cooking and Home Food Preservation fermenting glass/ceramic weights/pebbles or miscellaneous implement storage container with images of lid open and lid closed. In this particular embodiment of the present invention, cooking and Home Food Preservation fermenting glass/ceramic weights/pebbles or miscellaneous implement storage container is shown with foam protectors for fermenting glass/ceramic weights/pebbles 33, lid 1, a plurality of exterior sidewalls 3 (four not shown), a lock latch upper attachment 4, a plurality of hinges 7, according to one embodiment of the present invention.

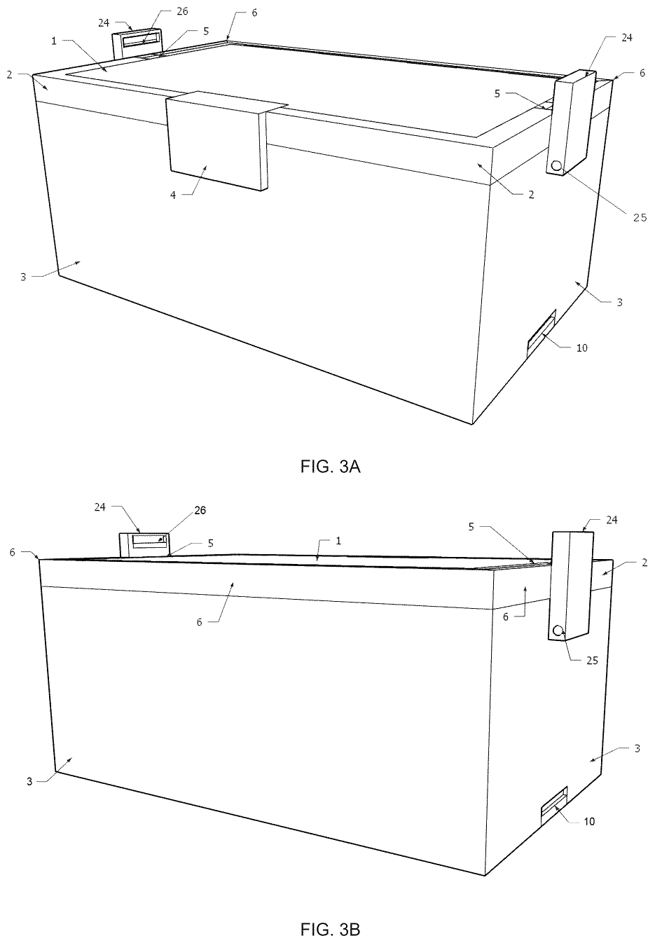

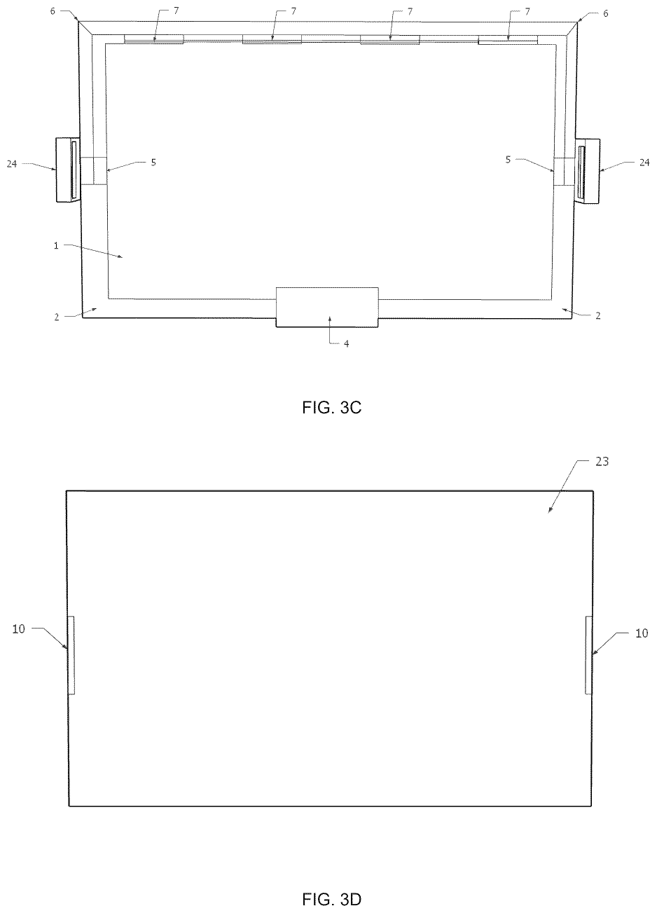

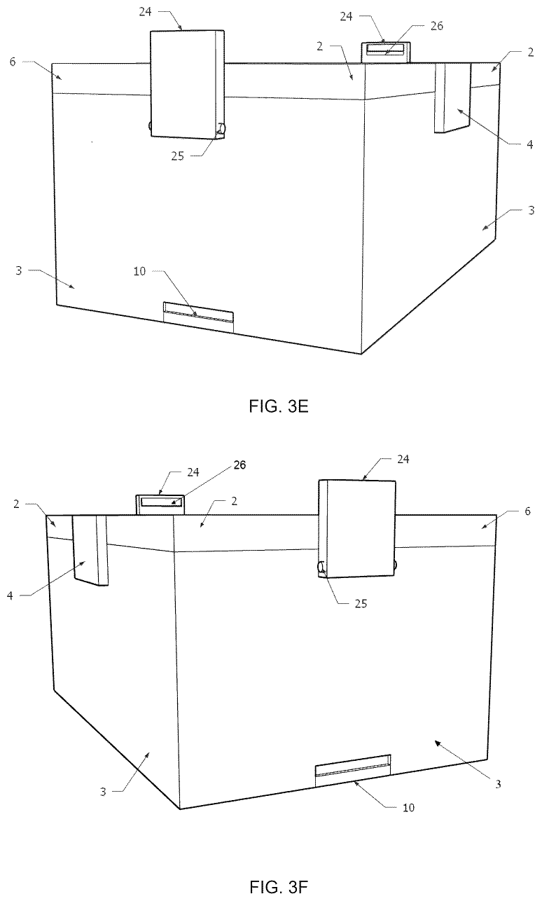

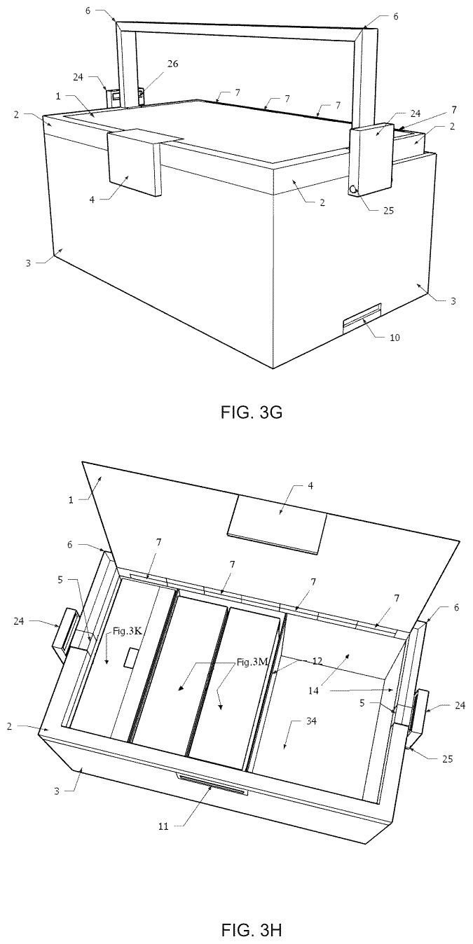

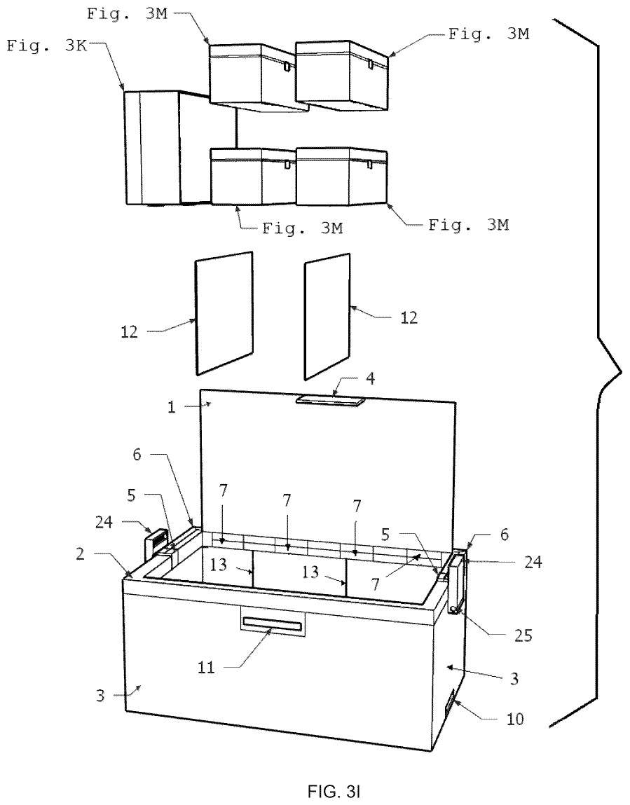

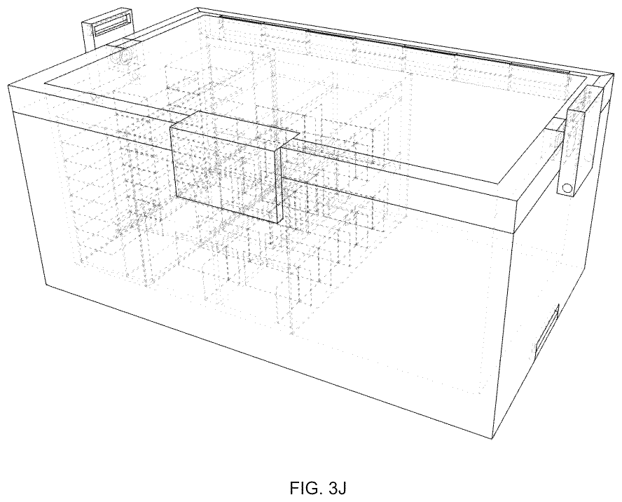

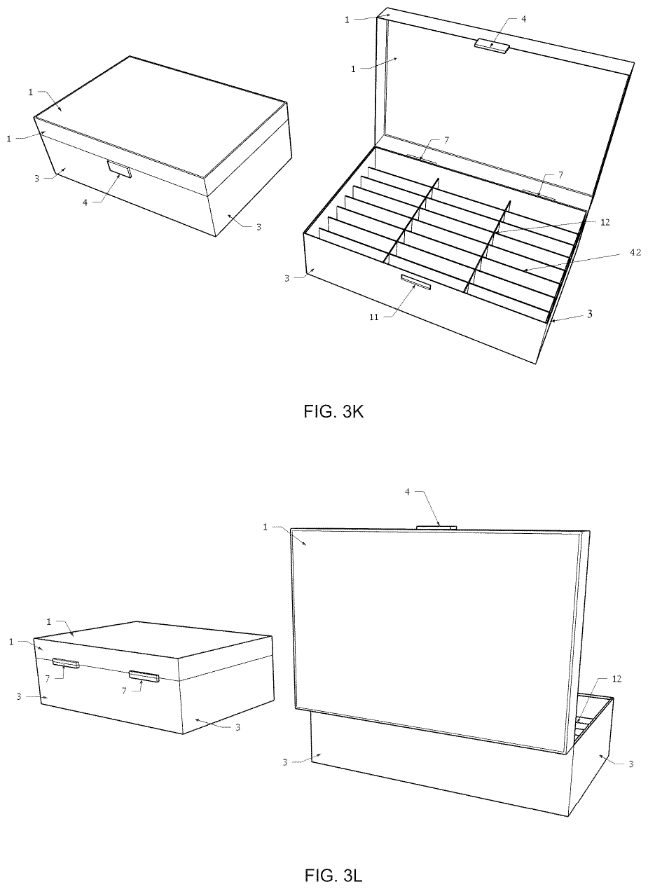

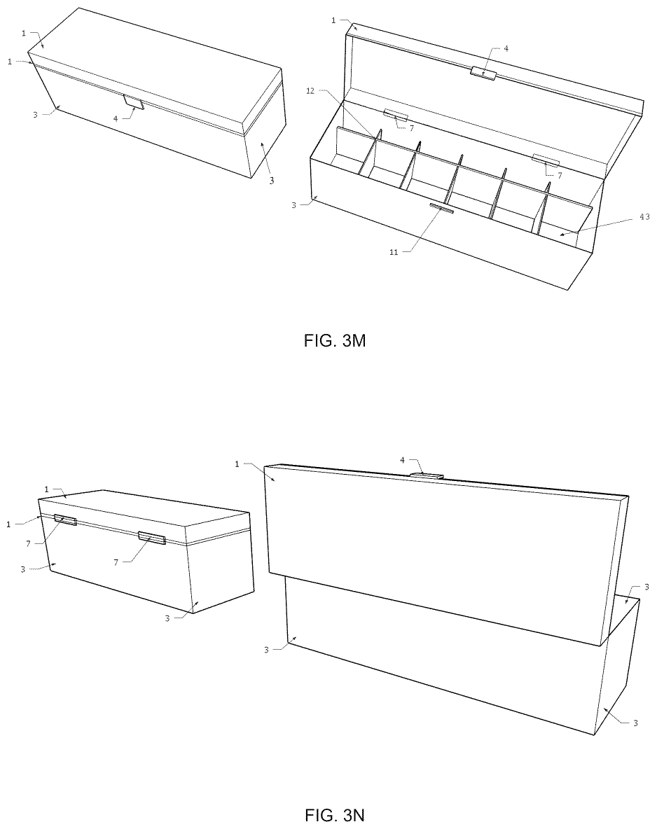

FIG. 3A shows one embodiment of the present invention of a front view of cooking and Home Food Preservation lids or miscellaneous implement storage container. In this particular embodiment of the present invention, cooking and Home Food Preservation lids or miscellaneous implement storage container is shown with a lid 1, a plurality of exterior sidewalls 3 (two not shown), a lock latch upper attachment 4, a top rim 2, a plurality of handle pivot hinges 5, a handle 6, a plurality of locking mechanism outer attachments 24, a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 3B shows one embodiment of the present invention of a back view of cooking and Home Food Preservation lids or miscellaneous implement storage container. In this particular embodiment of the present invention, cooking and Home Food Preservation lids or miscellaneous implement storage container is shown with a lid 1, a plurality of exterior sidewalls 3 (two not shown), a top rim 2, a plurality of handle pivot hinges 5, a handle 6, a plurality of locking mechanism outer attachments 24, a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 3C shows one embodiment of the present invention of a top view of cooking and Home Food Preservation lids or miscellaneous implement storage container. In this particular embodiment of the present invention, cooking and Home Food Preservation lids or miscellaneous implement storage container is shown with a lid 1, a lock latch upper attachment 4, a top rim 2, a plurality of handle pivot hinges 5, a handle 6, and a plurality of hinges 7, a plurality of locking mechanism outer attachments 24, according to one embodiment of the present invention.

FIG. 3D shows one embodiment of the present invention of a bottom view of cooking and Home Food Preservation lids or miscellaneous implement storage container. In this particular embodiment of the present invention, cooking and Home Food Preservation lids or miscellaneous implement storage container is shown with a base of storage container 23, a plurality of locking mechanism inner attachments 10, according to one embodiment of the present invention.

FIG. 3E shows one embodiment of the present invention of a left view of cooking and Home Food Preservation lids or miscellaneous implement storage container. In this particular embodiment of the present invention, cooking and Home Food Preservation lids or miscellaneous implement storage container is shown with a plurality of exterior sidewalls 3 (two not shown), a lock latch upper attachment 4, a top rim 2, a handle 6, a plurality of locking mechanism outer attachments 24, a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 3F shows one embodiment of the present invention of a right view of cooking and Home Food Preservation lids or miscellaneous implement storage container. In this particular embodiment of the present invention, cooking and Home Food Preservation lids or miscellaneous implement storage container is shown a plurality of exterior sidewalls 3 (two not shown), a lock latch upper attachment 4, a top rim 2, a handle 6, a plurality of locking mechanism outer attachments 24 (one not shown), a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 3G shows one embodiment of the present invention of a front view of handle extended on cooking and Home Food Preservation lids or miscellaneous implement storage container. In this particular embodiment of the present invention, cooking and Home Food Preservation lids or miscellaneous implement storage container is shown a lid 1, a plurality of exterior sidewalls 3 (two not shown), a lock latch upper attachment 4, a top rim 2, a handle 6, and a plurality of hinges 7, a plurality of locking mechanism outer attachments 24, a plurality of locking mechanism hinges 25 (one not shown), a plurality of locking mechanism inner attachments 26 (one not shown), a plurality of locking mechanism inner attachments 10 (one not shown), according to one embodiment of the present invention.

FIG. 3H shows one embodiment of the present invention of a top view of lid open on cooking and Home Food Preservation lids or miscellaneous implement storage container. In this particular embodiment of the present invention, cooking and Home Food Preservation lids or miscellaneous implement storage container is shown with permanent or demountable dividers 12 inside the storage container. The dividers may be configured inside the storage container in various possible locations as well as demounted to create a larger storage compartment according to the user's need and preferences. The dividers 12 create compartments for cooking and Home Food Preservation reusable plastic/glass lids or miscellaneous implement storage container (FIG. 3K), cooking and Home Food Preservation disposable metal lids or miscellaneous implement storage container (FIG. 3M), or miscellaneous implement storage compartments for implements including but not limited to; apple peeler/corers, cherry seed pitting tools, strawberry hullers, tongs, zesters, knives, slicing tools, peelers, freezer bags. Also shown are a plurality of exterior sidewalls 3 (three not shown), interior sidewalls 14, a lid 1, a lock latch upper attachment 4, a top rim 2, a plurality of handle pivot hinges 5, a handle 6, and a plurality of hinges 7, a plurality of locking mechanism outer attachments 24, a lock latch lower attachment 11, a plurality of locking mechanism hinges 25 (one not shown), an apple peeler corers/miscellaneous storage compartment, FIG. 3K (a front view of cooking and Home Food Preservation reusable plastic/glass lids or miscellaneous implement storage container with images of lid open and lid closed) and FIG. 3M (a front view of cooking and Home Food Preservation disposable metal lids or miscellaneous implement storage container with images of lid open and lid closed), according to one embodiment of the present invention.

FIG. 3I shows one embodiment of the present invention of an exploded view of FIG. 3A cooking and Home Food Preservation lids or miscellaneous implement storage container. In this particular embodiment of the present invention, cooking and Home Food Preservation lids or miscellaneous implement storage container is shown with permanent or demountable dividers 12, demounted above the storage container, creating an optional larger storage compartment for the user's needs and preferences. This embodiment of the present invention is shown with a lid 1, a plurality of exterior sidewalls 3 (two not shown), a lock latch upper attachments 4, a top rim 2, a plurality of handle pivot hinges 5, a handle 6, and a plurality of hinges 7, divider guides 13, a plurality of locking mechanism inner attachments 10 (one not shown), a lock latch lower attachment 11, a plurality of locking mechanism outer attachments 24, a plurality of locking mechanism hinges 25 (one not shown), FIG. 3K (cooking and Home Food Preservation reusable plastic/glass lids or miscellaneous implement storage container), and FIG. 3M (cooking and Home Food Preservation disposable metal lids or miscellaneous implement storage container), according to one embodiment of the present invention.

FIG. 3J shows one embodiment of the present invention of a front Xray view of FIG. 3A cooking and Home Food Preservation lids or miscellaneous implement storage container. In this particular embodiment of the present invention, cooking and Home Food Preservation lids or miscellaneous implement storage container is shown as a front Xray view, according to one embodiment of the present invention.

FIG. 3K is a front view of cooking and Home Food Preservation reusable plastic/glass lids or miscellaneous implement storage container with images of lid open and lid closed. In this particular embodiment of the present invention, the cooking and Home Food Preservation reusable plastic/glass lids or miscellaneous implement storage container is shown with permanent or demountable dividers 12, lid 1, a plurality of exterior sidewalls 3 (four not shown), a lock latch upper attachment 4, a lock latch lower attachment 11, a plurality of hinges 7, and reusable plastic lids or miscellaneous storage compartments 42, according to one embodiment of the present invention.

FIG. 3L is a back view of cooking and Home Food Preservation reusable plastic/glass lids or miscellaneous implement storage container with images of lid open and lid closed. In this particular embodiment of the present invention, the cooking and Home Food Preservation reusable plastic/glass lids or miscellaneous implement storage container is shown with permanent or demountable dividers 12, a lid 1, a plurality of exterior sidewalls 3 (four not shown), a lock latch upper attachment 4, a plurality of hinges 7, according to one embodiment of the present invention.

FIG. 3M is a front view of cooking and Home Food Preservation disposable metal lids or miscellaneous implement storage container with images of lid open and lid closed. In this particular embodiment of the present invention, the cooking and Home Food Preservation disposable metal lids or miscellaneous implement storage container is shown with permanent or demountable dividers 12, a lid 1, a plurality of exterior sidewalls 3 (five not shown), a lock latch upper attachment 4, a plurality of hinges 7, a lock latch lower attachment 11, disposable metal lids reusable glass/ceramic lids storage compartments 43, according to one embodiment of the present invention.

FIG. 3N is a back view of cooking and Home Food Preservation disposable metal lids or miscellaneous implement storage container with images of lid open and lid closed. In this particular embodiment of the present invention, the cooking and Home Food Preservation disposable metal lids or miscellaneous implement storage container is shown with a lid 1, a plurality of exterior sidewalls 3 (four not shown), a lock latch upper attachment 4, a plurality of hinges 7, according to one embodiment of the present invention.

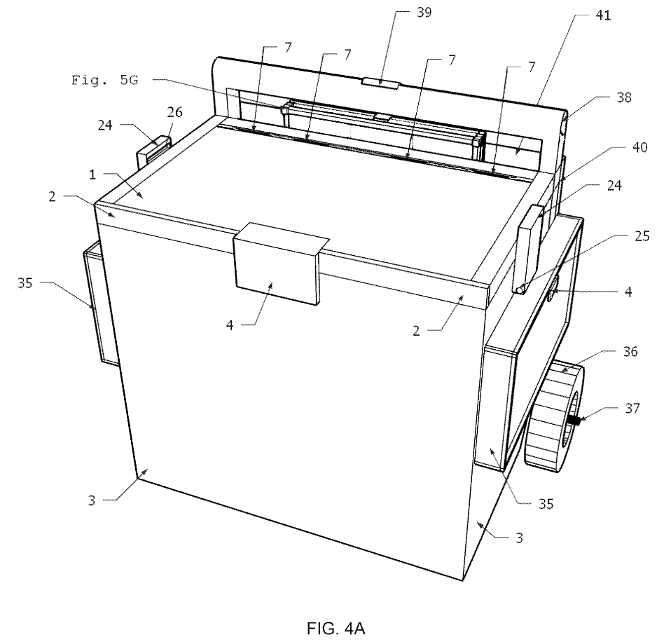

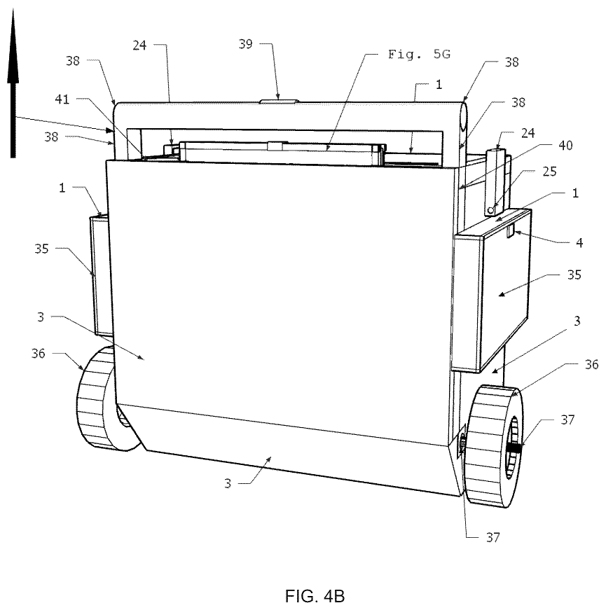

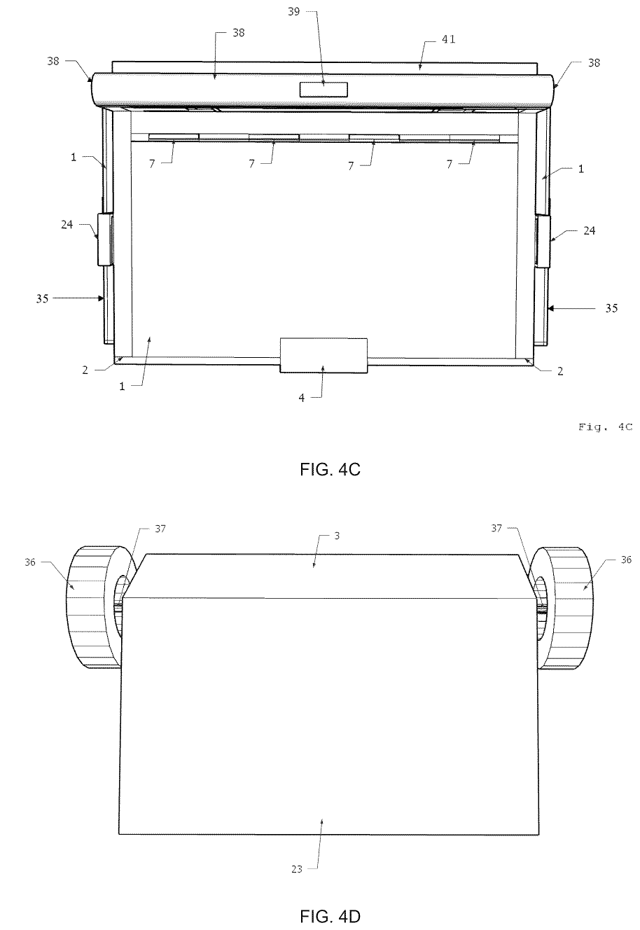

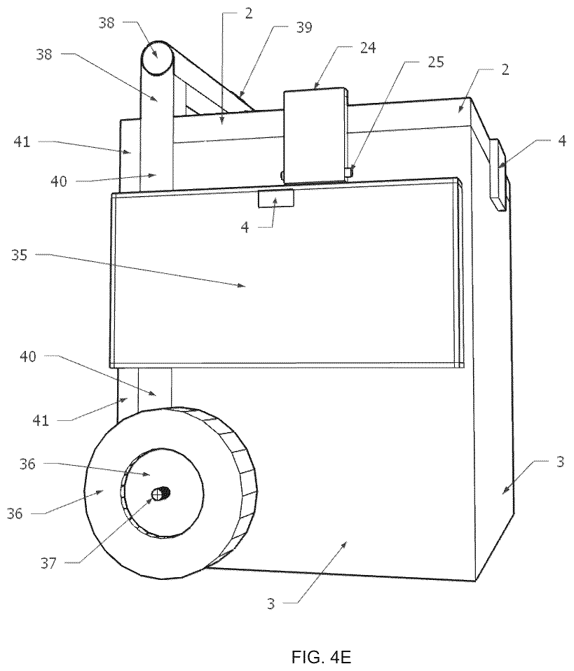

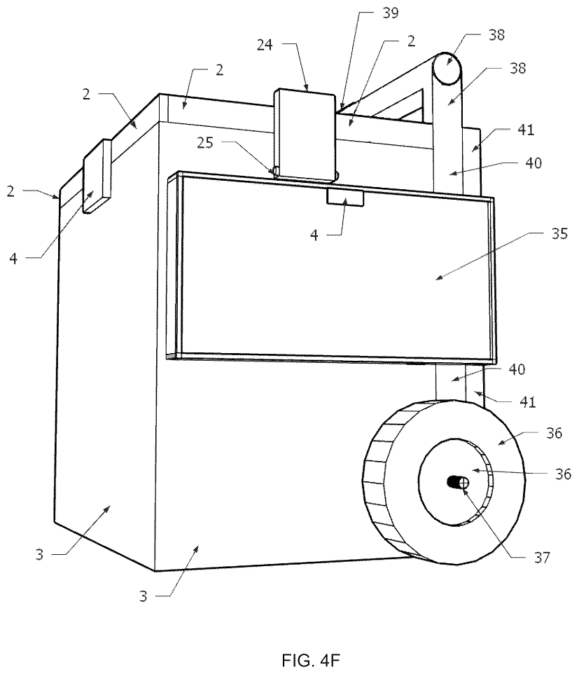

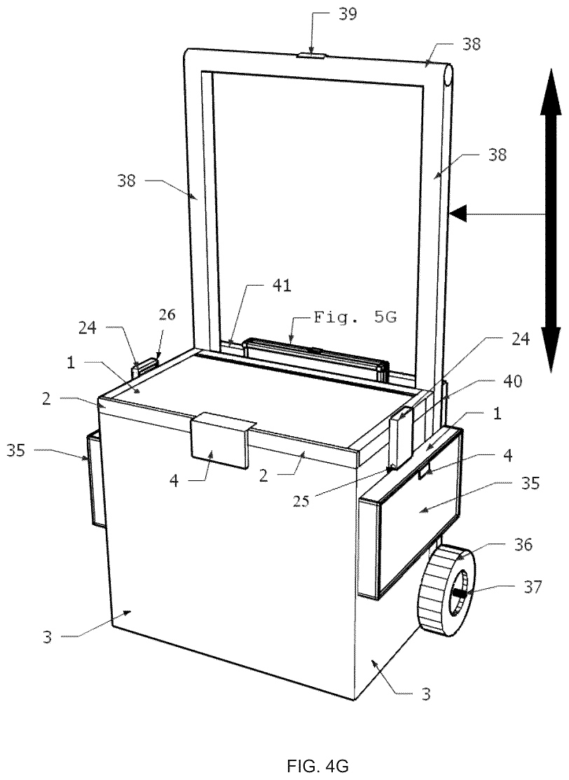

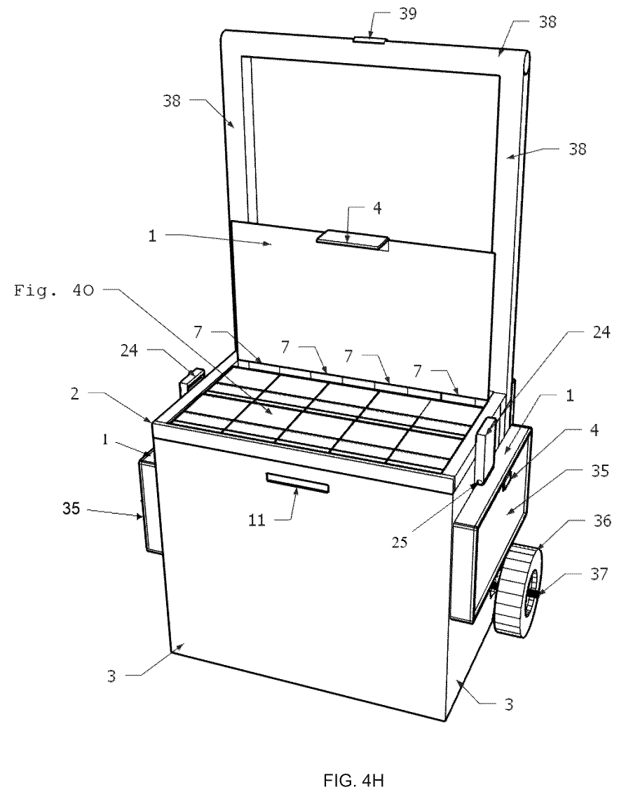

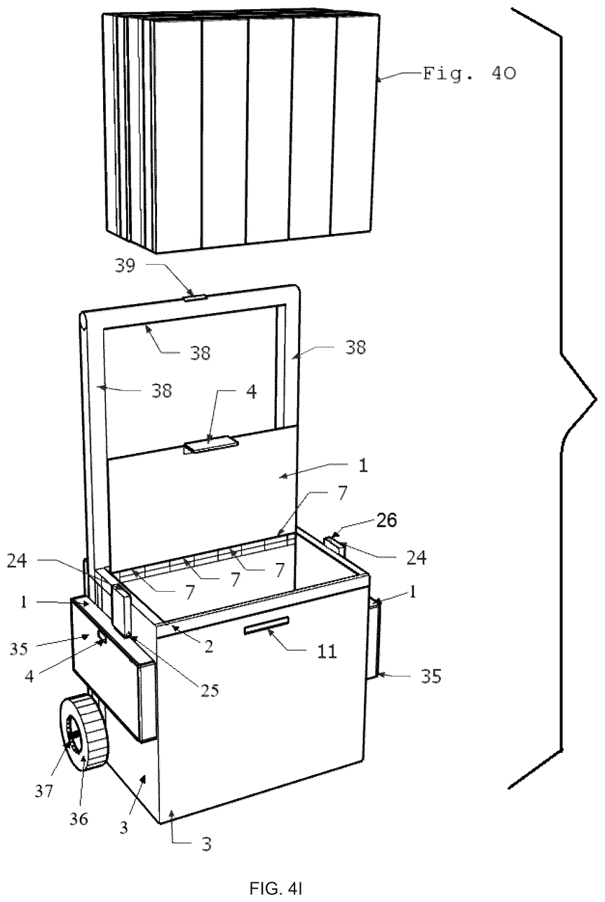

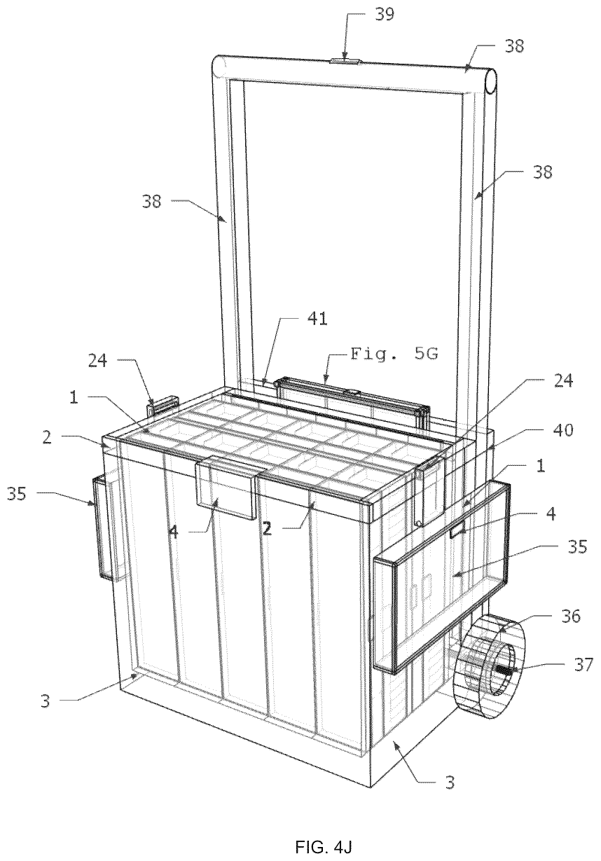

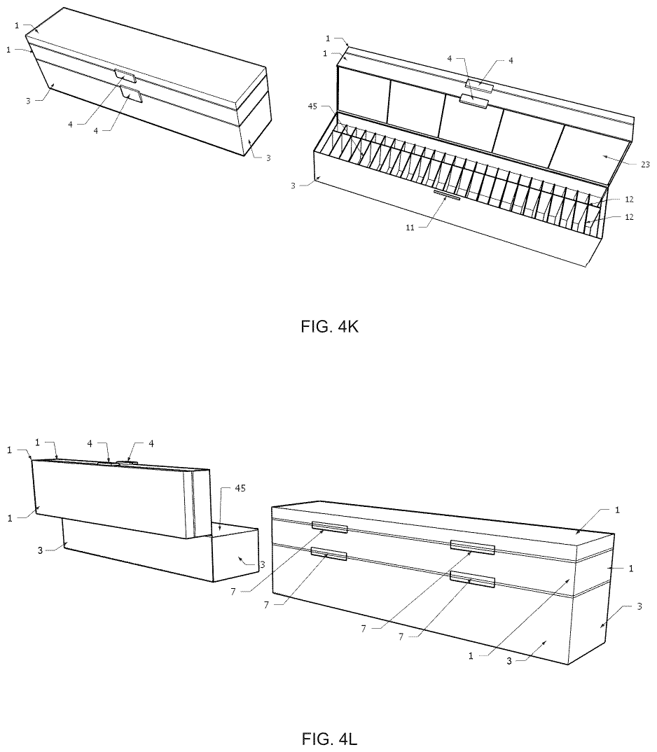

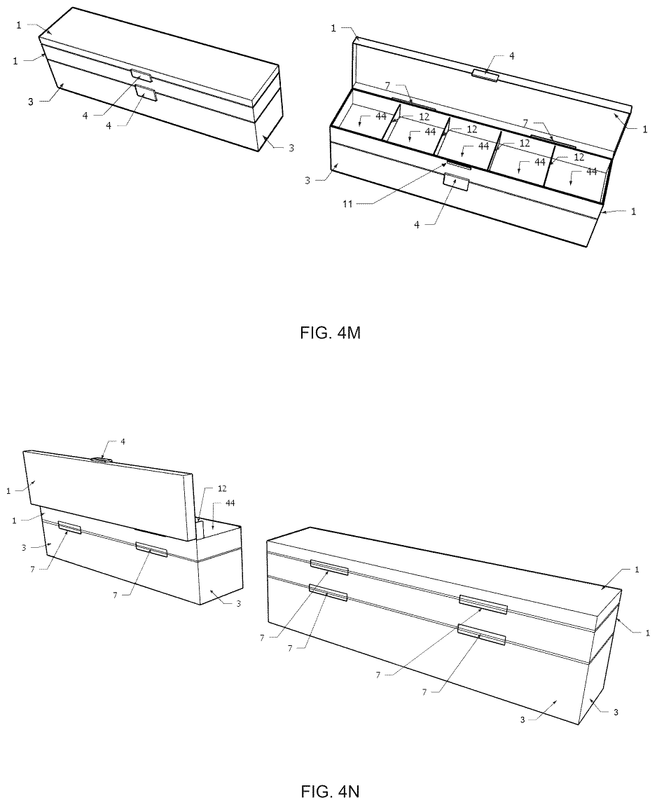

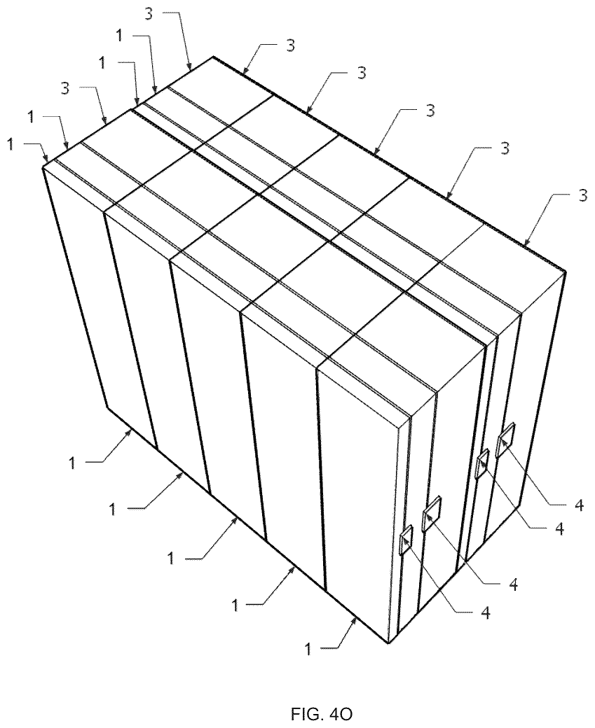

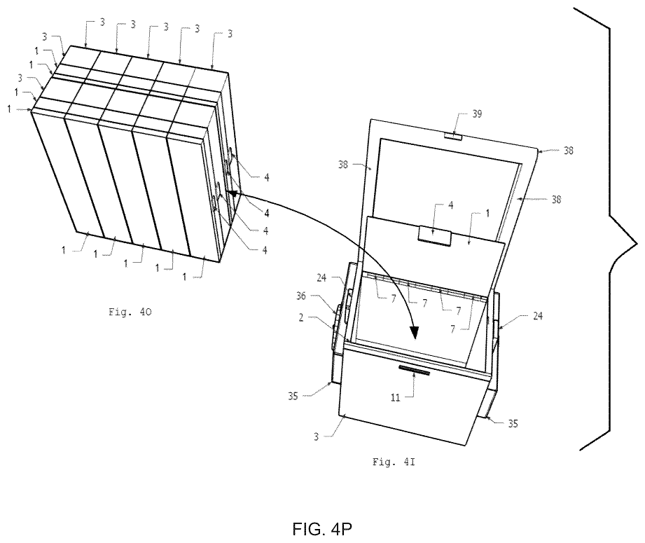

FIG. 4A shows one embodiment of the present invention of a front view of

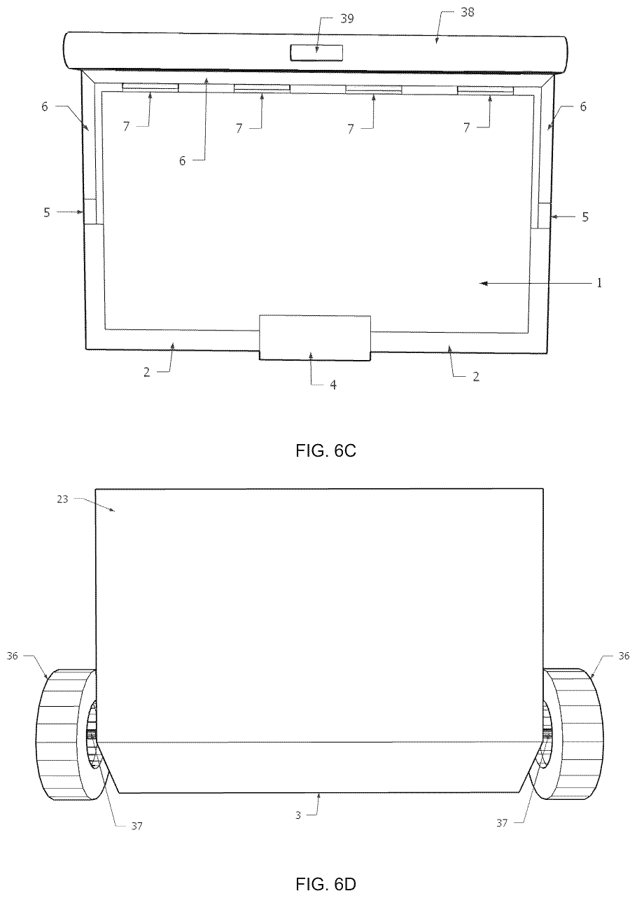

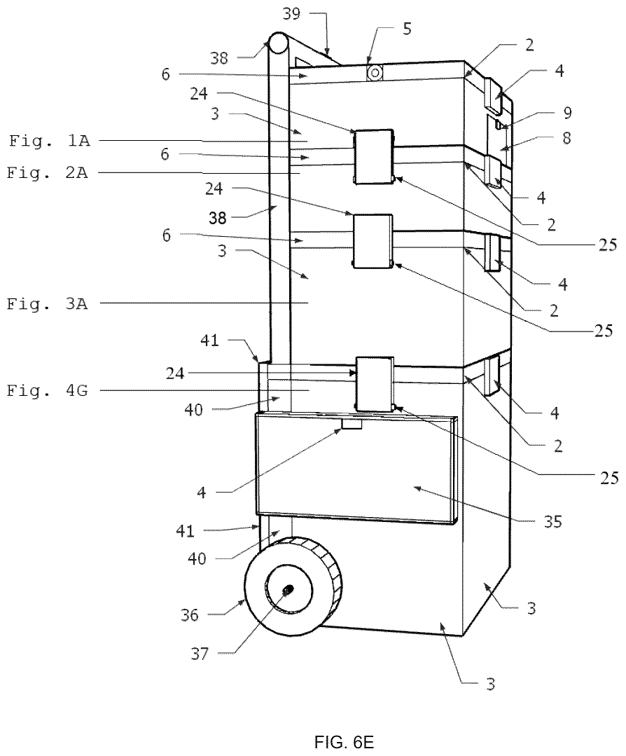

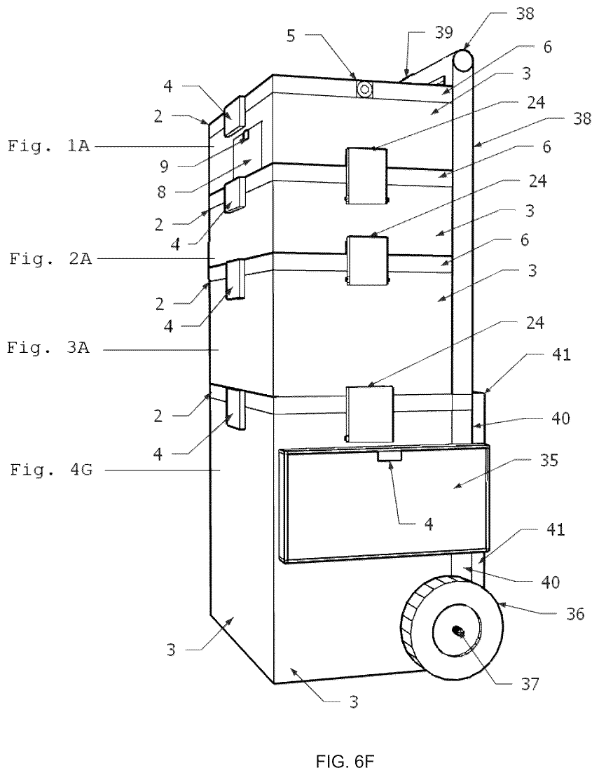

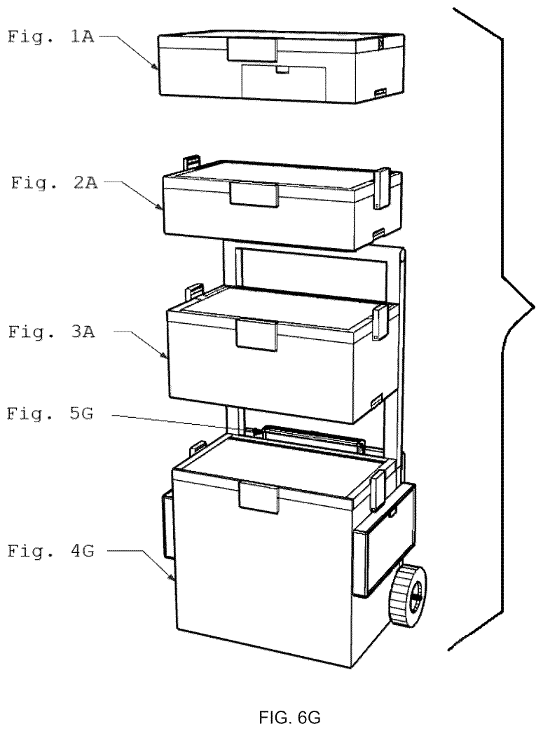

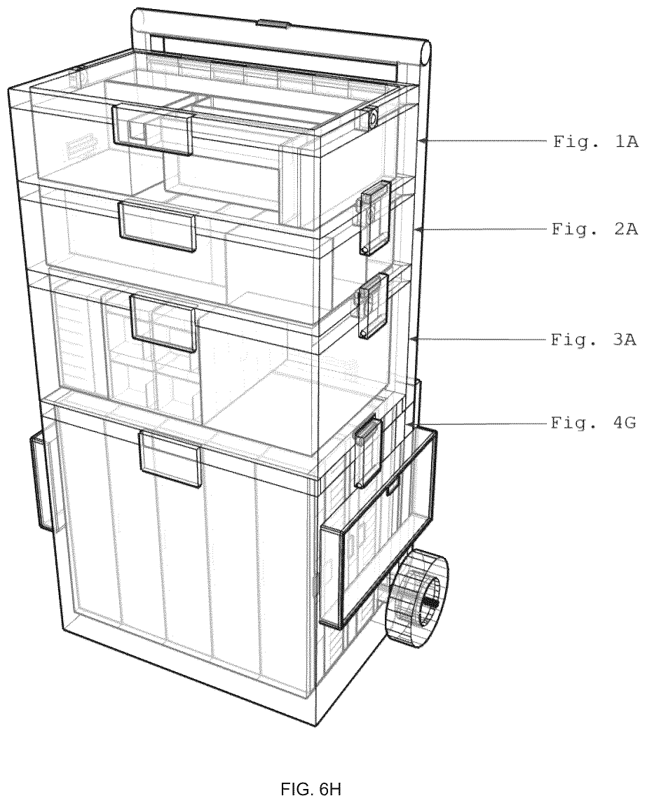

cooking and Home Food Preservation canning ring band or miscellaneous implement storage container. In this particular embodiment of the present invention, cooking and Home Food Preservation canning ring band or miscellaneous implement storage container is shown with a lid 1, a top rim 2, a plurality of exterior sidewalls 3 (two not shown), a plurality of lock latch upper attachments 4 (one not shown), a plurality of hinges 7, a plurality of locking mechanism outer attachments 24, a plurality of locking mechanism hinges 25 (one not shown), a plurality of locking mechanism inner attachments 26 (one not shown), a plurality of cookbooks/instruction manuals storage compartments 35, a plurality of wheels 36 (one not shown), a wheel axle 37, an extendable handle 38, an extendable handle lock 39, an extendable handle base 40, jar storage containers/miscellaneous storage compartment 41, FIG. 6G (FIG. 6G is a view of cooking and Home Food Preservation jar/mason jar or miscellaneous implement storage container collapsed and locked together with all permanent or demountable exterior sidewalls dividers of jar/mason jar storage container fitted inside), according to one embodiment of the present invention.

FIG. 4B shows one embodiment of the present invention of a back view of cooking and Home Food Preservation canning ring band or miscellaneous implement storage container. In this particular embodiment of the present invention, cooking and Home Food Preservation canning ring band or miscellaneous implement storage container is shown with a lid 1, a plurality of exterior sidewalls 3 (two not shown), a plurality of lock latch upper attachments 4 (two not shown), a plurality of locking mechanism outer attachments 24, a plurality of locking mechanism hinges 25 (one not shown), a plurality of cookbooks/instruction manuals storage compartments 35, a plurality of wheels 36, a wheel axle 37, an extendable handle 38, an extendable handle lock 39, an extendable handle base 40, jar storage containers/miscellaneous storage compartment 41, FIG. 6G (FIG. 6G is a view of jar/mason jar storage container collapsed and locked together with all permanent or demountable exterior sidewalls dividers of jar/mason jar storage container fitted inside), and an arrow indicating the possible raised extension of the extendable handle 38, according to one embodiment of the present invention.

FIG. 4C shows one embodiment of the present invention of a top view of cooking and Home Food Preservation canning ring band or miscellaneous implement storage container. In this particular embodiment of the present invention, cooking and Home Food Preservation canning ring band or miscellaneous implement storage container is shown with a lid 1, a top rim 2, a plurality of lock latch upper attachments 4 (two not shown), a plurality of hinges 7, a plurality of locking mechanism outer attachments 24, cookbooks/instruction manuals storage compartments 35, an extendable handle 38, an extendable handle lock 39, jar storage containers/miscellaneous storage compartment 41, according to one embodiment of the present invention.

FIG. 4D shows one embodiment of the present invention of a bottom view of cooking and Home Food Preservation canning ring band or miscellaneous implement storage container. In this particular embodiment of the present invention, cooking and Home Food Preservation canning ring band or miscellaneous implement storage container is shown with a plurality of exterior sidewalls 3 (three not shown), base of storage container 23, a plurality of wheels 36, a wheel axle 37, an extendable handle 38, an extendable handle lock 39, an extendable handle base 40, jar storage containers/miscellaneous storage compartment 41, according to one embodiment of the present invention.

FIG. 4E shows one embodiment of the present invention of a left view of cooking and Home Food Preservation canning ring band or miscellaneous implement storage container. In this particular embodiment of the present invention, cooking and Home Food Preservation canning ring band or miscellaneous implement storage container is shown with a top rim 2, a plurality of exterior sidewalls 3 (two not shown), a plurality of lock latch upper attachments 4 (one not shown), a plurality of locking mechanism outer attachments 24 (one not shown), a plurality of locking mechanism hinges 25 (one not shown), a plurality of cookbooks/instruction manuals storage compartments 35 (one not shown), a plurality of wheels 36 (one not shown), a wheel axle 37, an extendable handle 38, an extendable handle lock 39, an extendable handle base 40, jar storage containers/miscellaneous storage compartment 41, according to one embodiment of the present invention.

FIG. 4F shows one embodiment of the present invention of a right view of cooking and Home Food Preservation canning ring band or miscellaneous implement storage container. In this particular embodiment of the present invention, cooking and Home Food Preservation canning ring band or miscellaneous implement storage container is shown with a top rim 2, a plurality of exterior sidewalls 3 (two not shown), a plurality of lock latch upper attachments 4 (one not shown), a plurality of locking mechanism outer attachments 24 (one not shown), a plurality of locking mechanism hinges 25 (one not shown), a plurality of locking mechanism inner attachments 26 (one not shown), a plurality of cookbooks/instruction manuals storage compartments 35 (one not shown), a plurality of wheels 36 (one not shown), a wheel axle 37, an extendable handle 38, an extendable handle lock 39, an extendable handle base 40, jar storage containers/miscellaneous storage compartment 41, according to one embodiment of the present invention.

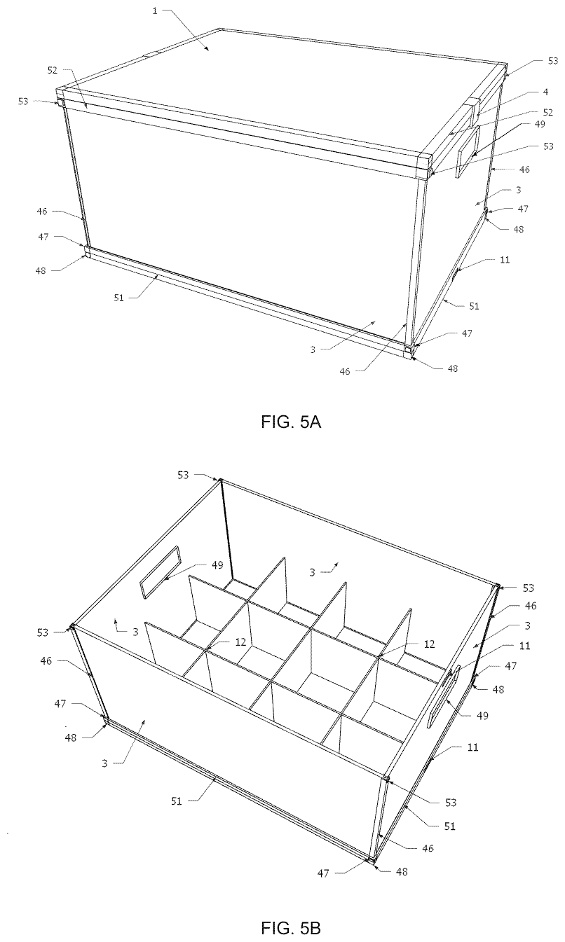

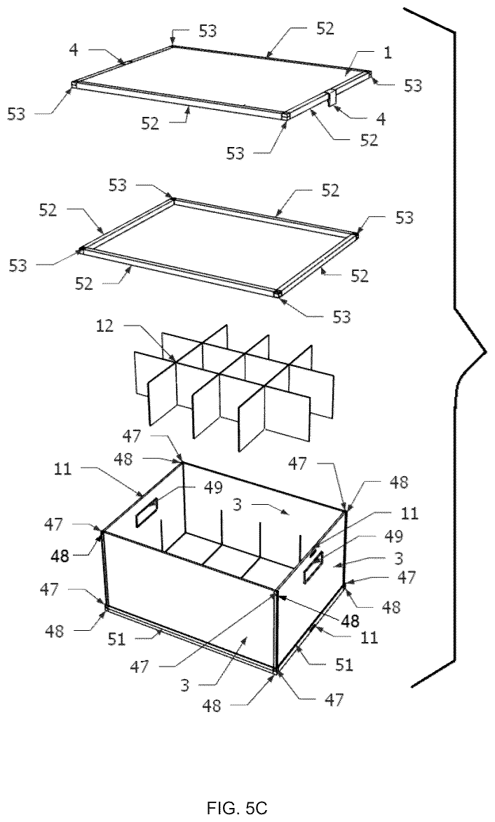

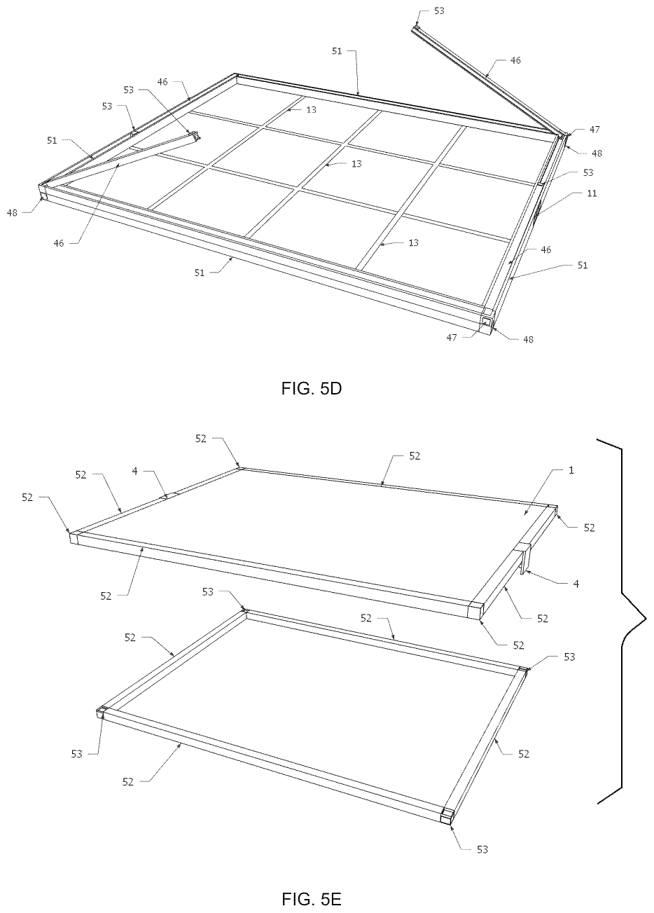

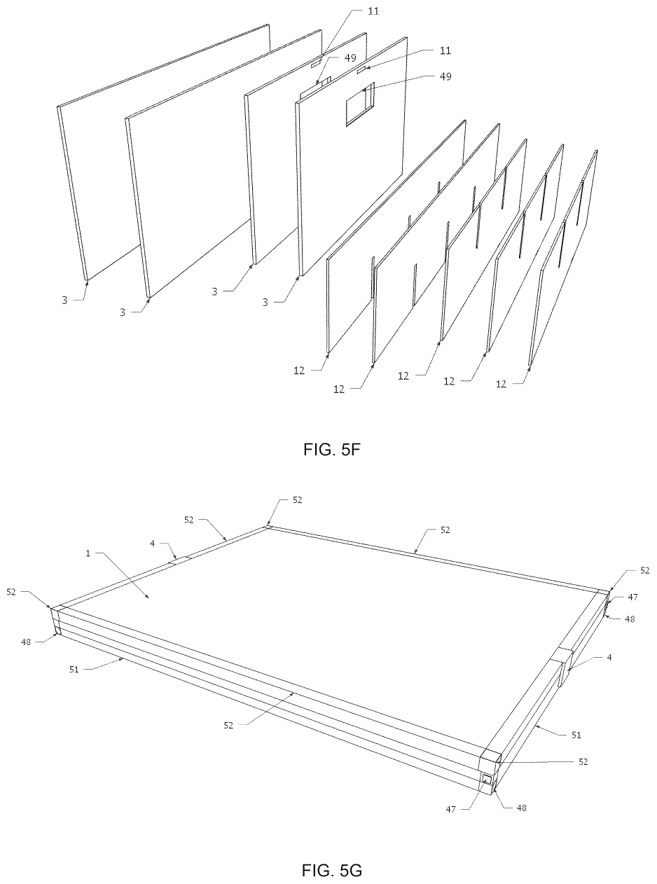

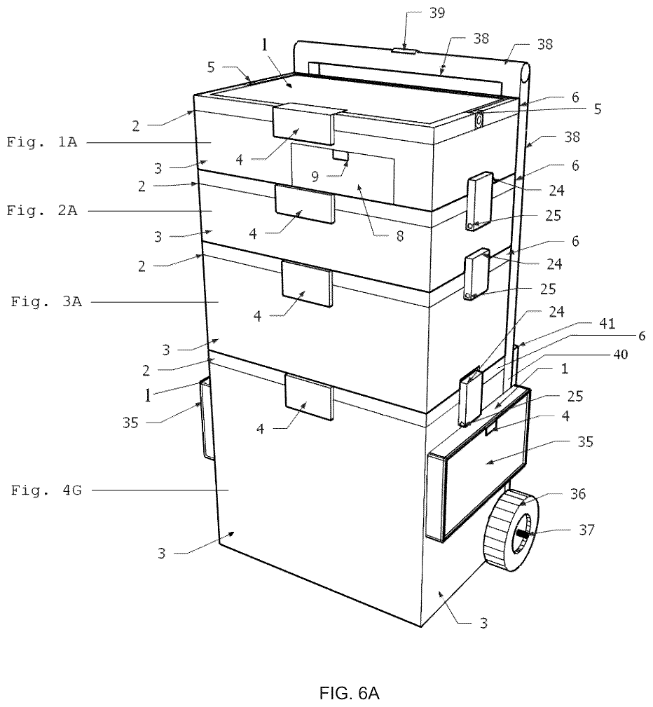

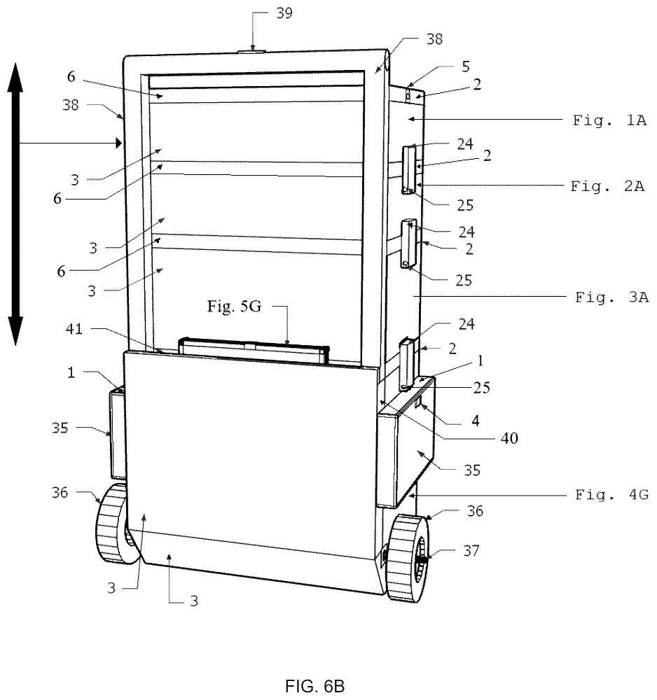

FIG. 4G shows one embodiment of the present invention of a front view of handle extended on cooking and Home Food Preservation canning ring band or miscellaneous implement storage container. In this particular embodiment of the present invention, cooking and Home Food Preservation canning ring band or miscellaneous implement storage container is shown with a lid 1, a top rim 2, a plurality of exterior sidewalls 3 (two not shown), a plurality of lock latch upper attachments 4 (one not shown), a plurality of locking mechanism outer attachments 24, a plurality of locking mechanism hinges 25 (one not shown), a plurality of locking mechanism inner attachments 26 (one not shown), a plurality of cookbooks/instruction manuals storage compartments 35, a plurality of wheels 36 (one not shown), a wheel axle 37, an extendable handle 38, an extendable handle lock 39, an extendable handle base 40, jar storage containers/miscellaneous storage compartment 41, FIG. 6G (FIG. 6G is a view of jar/mason jar storage container (FIG. 5G) collapsed and locked together with all permanent or demountable exterior sidewalls 3, and dividers 12, of jar/mason jar storage container (FIG. 5G) fitted inside), and an arrow indicating the extendable handle raised or lowered positions, according to one embodiment of the present invention.

FIG. 4H shows one embodiment of the present invention of a top view of lid open on cooking and Home Food Preservation canning ring band or miscellaneous implement storage container. In this particular embodiment of the present invention, cooking and Home Food Preservation canning ring band or miscellaneous implement storage container is shown with a lid 1, a top rim 2, a plurality of exterior sidewalls 3 (two not shown), a plurality of lock latch upper attachments 4 (one not shown), a plurality of hinges 7, a lock latch lower attachment 11, a plurality of locking mechanism outer attachments 24, a plurality of locking mechanism hinges 25 (one not shown), a plurality of cookbooks/instruction manuals storage compartments 35, wheels 36 (one not shown), a wheel axle 37, an extendable handle 38, an extendable handle lock 39, FIG. 4O (FIG. 4O is a top view of 10 cooking and Home Food Preservation canning ring band, reusable plastic/glass lids, rubber/silicone gaskets/rings implement storage container to fit inside FIG. 4A), according to one embodiment of the present invention.

FIG. 4I shows one embodiment of the present invention of an exploded view of cooking and Home Food Preservation canning ring band or miscellaneous implement storage container. In this particular embodiment of the present invention, cooking and Home Food Preservation canning ring band or miscellaneous implement storage container is shown with a lid 1, a top rim 2, a plurality of exterior sidewalls 3 (two not shown), a plurality of lock latch upper attachments 4 (one not shown), a plurality of hinges 7, a lock latch lower attachment 11, a plurality of locking mechanism outer attachments 24, a plurality of locking mechanism hinges 25 (one not shown), a plurality of locking mechanism inner attachments 26 (one not shown), a plurality of cookbooks/instruction manuals storage compartments 35, a plurality of wheels 36 (one not shown), a wheel axle 37, an extendable handle 38, an extendable handle lock 39, FIG. 4O (FIG. 4O is a perspective view of 10 cooking and Home Food Preservation canning ring band, reusable plastic/glass lids, rubber/silicone gaskets/rings implement storage container to fit inside FIG. 4A), and FIG. 4I (FIG. 4I is an exploded view of cooking and Home Food Preservation canning ring band or miscellaneous implement storage container), according to one embodiment of the present invention.

FIG. 4J shows one embodiment of the present invention of a front Xray view of FIG. 4A cooking and Home Food Preservation canning ring band or miscellaneous implement storage container. In this particular embodiment of the present invention, cooking and Home Food Preservation canning ring band or miscellaneous implement storage container is shown as a front Xray view, according to one embodiment of the present invention.

FIG. 4K shows one embodiment of the present invention of a front view of lower compartments for cooking and Home Food Preservation canning ring band, reusable plastic/glass lids, rubber/silicone gaskets/rings implement storage container with images of lower lid open and both lids closed. In this particular embodiment of the present invention, the cooking and Home Food Preservation canning ring band, reusable plastic/glass lids, rubber/silicone gaskets/rings implement storage container is shown with permanent or demountable dividers 12, a plurality of lids 1, a plurality of exterior sidewalls 3 (five not shown), a lock latch upper attachment 4, a plurality of lock latch lower attachments 11, a plurality of base of storage container 23, and a canning ring band or reusable glass/ceramic lid storage compartments 45, according to one embodiment of the present invention.

FIG. 4L shows one embodiment of the present invention of a back view of lower compartments for cooking and Home Food Preservation canning ring band, reusable plastic/glass lids, rubber/silicone gaskets/rings implement storage container with images of lid open and lid closed. In this particular embodiment of the present invention, the cooking and Home Food Preservation canning ring band, reusable plastic/glass lids, rubber/silicone gaskets/rings implement storage container is shown with a plurality of lids 1, a plurality of exterior sidewalls 3 (four not shown), a plurality of lock latch upper attachments 4, a plurality of lock latch lower attachments 11, a plurality of base of storage container 23, a plurality of hinges 7, and a canning ring band or reusable glass/ceramic lid storage compartments 45, according to one embodiment of the present invention.

FIG. 4M shows one embodiment of the present invention of a front view of upper compartments for cooking and Home Food Preservation canning ring band, reusable plastic/glass lids, rubber/silicone gaskets/rings implement storage container with images of lid open and lid closed. In this particular embodiment of the present invention, the cooking and Home Food Preservation canning ring band, reusable plastic/glass lids, rubber/silicone gaskets/rings implement storage container is shown with permanent or demountable dividers 12, plurality of lids 1, a plurality of exterior sidewalls 3 (five not shown), a plurality of lock latch upper attachments 4, a plurality of lock latch lower attachments 11, a plurality of base of storage container 23, and a rubber/silicone gaskets/rings, canning ring bands, disposable metal lids storage compartments 44, according to one embodiment of the present invention.

FIG. 4N shows one embodiment of the present invention of a back view of upper compartments for cooking and Home Food Preservation canning ring band, reusable plastic/glass lids, rubber/silicone gaskets/rings implement storage container with images of lid open and lid closed. In this particular embodiment of the present invention, the cooking and Home Food Preservation canning ring band, reusable plastic/glass lids, rubber/silicone gaskets/rings implement storage container is shown with permanent or demountable dividers 12, a plurality of lids 1, a plurality of exterior sidewalls 3 (four not shown), a plurality of lock latch upper attachments 4, a plurality of lock latch lower attachments 11, a plurality of base of storage container 23, a plurality of hinges 7, and a rubber/silicone gaskets/rings, canning ring bands, disposable metal lids storage compartments 44, according to one embodiment of the present invention.

FIG. 4O shows one embodiment of the present invention of a front view of 10 cooking and Home Food Preservation canning ring band, reusable plastic/glass lids, rubber/silicone gaskets/rings implement storage container next to each other to fit inside FIG. 4A. In this particular embodiment of the present invention, the cooking and Home Food Preservation canning ring band, reusable plastic/glass lids, rubber/silicone gaskets/rings implement storage container is shown with lids 1, a plurality of exterior sidewalls 3, a lock latch upper attachments 4, according to one embodiment of the present invention.

FIG. 4P shows one embodiment of the present invention of a front view of possible placement of FIG. 4O storage containers inside FIG. 4I, storage containers are shown with a plurality of lids 1, a plurality of top rims 2, a plurality of exterior sidewalls 3, a plurality of lock latch upper attachments 4 (one not shown), a plurality of hinges 7, a lock latch lower attachment 11, a plurality of locking mechanism outer attachments 24, cookbooks/instruction manuals storage compartments 35, wheels 36 (one not shown), wheel axle 37, an extendable handle 38, an extendable handle lock 39, according to one embodiment of the present invention.

FIG. 5A shows one embodiment of the present invention of a front view of cooking and Home Food Preservation jar/mason jar or miscellaneous implement storage container. In this particular embodiment of the present invention, cooking and Home Food Preservation jar/mason jar or miscellaneous implement storage container is shown with a lid 1, a plurality of exterior sidewalls 3 (two not shown), a lock latch upper attachment 4, a plurality of lock latch lower attachments 11 (one not shown), permanent or demountable dividers 12, a base of storage container 23, pivoting/collapsable structural frame 46, a plurality of locks for pivoting/collapsable structural frame 47 (one not shown), a plurality of pivot hinges 48 (one not shown), a plurality of handles/grips 49, jar storage compartments 50, base frame 51, lid frame 52, and a plurality of corner frame locks 53 (one not shown), according to one embodiment of the present invention.

FIG. 5B shows one embodiment of the present invention of a top view with lid off of cooking and Home Food Preservation jar/mason jar or miscellaneous implement storage container. In this particular embodiment of the present invention, cooking and Home Food Preservation jar/mason jar or miscellaneous implement storage container is shown with a plurality of exterior sidewalls 3, a plurality of lock latch lower attachments 11, permanent or demountable dividers 12, pivoting/collapsable structural frame 46, a plurality of handles/grips 49, jar storage compartments 50, base frame 51, according to one embodiment of the present invention.

FIG. 5C shows one embodiment of the present invention of an exploded view of cooking and Home Food Preservation jar/mason jar or miscellaneous implement storage container. In this particular embodiment of the present invention, cooking and Home Food Preservation jar/mason jar or miscellaneous implement storage container is shown with a lid 1, a plurality of exterior sidewalls 3, a lock latch upper attachment 4 (one not shown), a plurality of lock latch lower attachments 11, permanent or demountable dividers 12, pivoting/collapsable structural frame 46, a plurality of locks for pivoting/collapsable structural frame 47, a plurality of handles/grips 49, base frame 51, lid frame 52, and a plurality of corner frame locks 53, according to one embodiment of the present invention.

FIG. 5D is a view of cooking and Home Food Preservation jar/mason jar or miscellaneous implement storage container base frame with 2 of 4 pivoting/collapsable structural frame corners partially extended and 2 of 4 pivoting/collapsable structural frame corners folded into the frame. In this particular embodiment of the present invention, cooking and Home Food Preservation jar/mason jar or miscellaneous implement storage container is shown with a plurality of lock latch lower attachments 11 (one not shown), a plurality of divider guides 13, a plurality of pivot hinges 48 (one not shown), base frame 51, and a plurality of corner frame locks 53, according to one embodiment of the present invention.

FIG. 5E shows one embodiment of the present invention of a view of cooking and Home Food Preservation jar/mason jar or miscellaneous implement storage container lid and locking rim of container. In this particular embodiment of the present invention, is shown with a lid 1, a plurality of lock latch upper attachments 4, lid frame 52, and a plurality of corner frame locks 53, according to one embodiment of the present invention.

FIG. 5F shows one embodiment of the present invention of a view of exterior walls 3, and permanent or demountable dividers 12, for cooking and Home Food Preservation jar/mason jar or miscellaneous implement storage container. In this particular embodiment of the present invention, cooking and Home Food Preservation jar/mason jar or miscellaneous implement storage container is shown with a plurality of exterior sidewalls 3, a plurality of lock latch lower attachments 11 (one not shown), permanent or demountable dividers 12, and a plurality of handles/grips 49, according to one embodiment of the present invention.

FIG. 5G is a view of cooking and Home Food Preservation jar/mason jar or miscellaneous implement storage container collapsed and locked together with all permanent or demountable exterior sidewalls and dividers of cooking and Home Food Preservation jar/mason jar or miscellaneous implement storage container fitted inside. In this particular embodiment of the present invention, cooking and Home Food Preservation jar/mason jar or miscellaneous implement storage container is shown with a lid 1, a top rim 2, exterior sidewalls 3, a plurality of lock latch upper attachments 4, permanent or demountable dividers 12, a plurality of pivot hinges 48 (one not shown), base frame 51, lid frame 52, and a plurality of corner frame locks 53 (one not shown), according to one embodiment of the present invention.

FIG. 6A shows one embodiment of the present invention of a front view of cooking and Home Food Preservation implement system of portable storage container assembly, assembled as one unit. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), FIG. 4G, (FIG. 4G is a front view of handle extended on cooking and Home Food Preservation canning ring band or miscellaneous implement storage container), FIG. 5G, (FIG. 5G is a view of cooking and Home Food Preservation jar/mason jar or miscellaneous implement storage container collapsed and locked together with all permanent or demountable exterior sidewalls dividers of cooking and Home Food Preservation jar/mason jar or miscellaneous implement storage container fitted inside), a lid 1 (three not shown), a plurality of top rims 2, a plurality of exterior sidewalls 3, a plurality of lock latch upper attachments 4 (one not shown), a plurality of handle pivot hinges 5 (six not shown), a plurality of handles 6, pullout drawer 8, a button lock 9 for pullout drawer, a plurality of locking mechanism outer attachments 24 (three not shown), a plurality of locking mechanism hinges 25 (three not shown), a plurality of cookbooks/instruction manuals storage compartments 35, a plurality of wheels 36 (one not shown), a wheel axle 37, an extendable handle 38, an extendable handle lock 39, an extendable handle base 40, jar storage containers/miscellaneous storage compartment 41, according to one embodiment of the present invention.

FIG. 6B shows one embodiment of the present invention of a back view of cooking and Home Food Preservation implement system of portable storage container assembly, assembled as one unit with handle extended. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), FIG. 4G, (FIG. 4G is a front view of handle extended on cooking and Home Food Preservation canning ring band or miscellaneous implement storage container), FIG. 5G, (FIG. 5G is a view of cooking and Home Food Preservation jar/mason jar or miscellaneous implement storage container collapsed and locked together with all permanent or demountable exterior sidewalls dividers of cooking and Home Food Preservation jar/mason jar or miscellaneous implement storage container fitted inside), a lid 1 (four not shown), a plurality of top rims 2, a plurality of exterior sidewalls 3, a plurality of lock latch upper attachments 4 (five not shown), a plurality of handle pivot hinges 5 (seven not shown), a plurality of handles 6 (three not shown), a plurality of locking mechanism outer attachments 24 (three not shown), a plurality of locking mechanism hinges 25 (three not shown), a plurality of cookbooks/instruction manuals storage compartments 35, a plurality of wheels 36, a wheel axle 37, an extendable handle 38, an extendable handle lock 39, an extendable handle base 40, jar storage containers/miscellaneous storage compartment 41, according to one embodiment of the present invention.

FIG. 6C shows one embodiment of the present invention of a top view of cooking and Home Food Preservation implement system of portable storage container assembly, assembled as one unit. In this particular embodiment of the present invention, cooking and Home Food Preservation implement storage containers assembled as one unit is shown with a lid 1, a top rim 2, a lock latch upper attachments 4, a plurality of handle pivot hinges 5, a handle 6, a plurality of hinges 7, an extendable handle 38, an extendable handle lock 39, according to one embodiment of the present invention.

FIG. 6D shows one embodiment of the present invention of a bottom view of cooking and Home Food Preservation implement system of portable storage container assembly, assembled as one unit. In this particular embodiment of the present invention, cooking and Home Food Preservation implement storage containers assembled as one unit is shown with a plurality of exterior sidewalls 3 (one shown), base of storage container 23, a plurality of wheels 36, a wheel axle 37, according to one embodiment of the present invention.

FIG. 6E shows one embodiment of the present invention of a left view of cooking and Home Food Preservation implement system of portable storage container assembly, assembled as one unit. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), FIG. 4G, (FIG. 4G is a front view of handle extended on cooking and Home Food Preservation canning ring band or miscellaneous implement storage container), a plurality of top rims 2, a plurality of exterior sidewalls 3, a plurality of lock latch upper attachments 4 (one not shown), a plurality of handle pivot hinges 5 (five not shown), a plurality of handles 6, pullout drawer 8, a button lock 9 for pullout drawer, a plurality of locking mechanism outer attachments 24 (three not shown), a plurality of locking mechanism hinges 25 (three not shown), a plurality of cookbooks/instruction manuals storage compartments 35 (one not shown), a plurality of wheels 36 (one not shown), a wheel axle 37, an extendable handle 38, an extendable handle lock 39, an extendable handle base 40, jar storage containers/miscellaneous storage compartment 41, according to one embodiment of the present invention.

FIG. 6F shows one embodiment of the present invention of a right view of cooking and Home Food Preservation implement system of portable storage container assembly, assembled as one unit. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), FIG. 4G, (FIG. 4G is a front view of handle extended on cooking and Home Food Preservation canning ring band or miscellaneous implement storage container), a plurality of top rims 2, a plurality of exterior sidewalls 3, a plurality of lock latch upper attachments 4 (one not shown), a plurality of handle pivot hinges 5 (five not shown), a plurality of handles 6, pullout drawer 8, a button lock 9 for pullout drawer, a plurality of locking mechanism outer attachments 24 (three not shown), a plurality of locking mechanism hinges 25 (three not shown), a plurality of cookbooks/instruction manuals storage compartments 35 (one not shown), a plurality of wheels 36 (one not shown), a wheel axle 37, an extendable handle 38, an extendable handle lock 39, an extendable handle base 40, jar storage containers/miscellaneous storage compartment 41, according to one embodiment of the present invention.

FIG. 6G shows one embodiment of the present invention of an exploded view of cooking and Home Food Preservation implement system of portable storage container assembly, assembled as one unit. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), and FIG. 4G, (FIG. 4G is a front view of handle extended on cooking and Home Food Preservation canning ring band or miscellaneous implement storage container), according to one embodiment of the present invention.

FIG. 6H shows one embodiment of the present invention of a front Xray view of FIG. 5A cooking and Home Food Preservation implement system of portable storage container assembly, assembled as one unit. In this particular embodiment of the present invention, cooking and Home Food Preservation implement storage containers assembled as one unit is shown with; FIG. 1A (FIG. 1A is a front view of cooking and Home Food Preservation multipurpose or miscellaneous implement storage container), FIG. 2A, (FIG. 2A is a front view of cooking and Home Food Preservation fermenting or miscellaneous implement storage container), FIG. 3A, (FIG. 3A is a front view of cooking and Home Food Preservation lids or miscellaneous implement storage container), and FIG. 4G, (FIG. 4G is a front view of handle extended on cooking and Home Food Preservation canning ring band or miscellaneous implement storage container), according to one embodiment of the present invention.

I claim:

1. An apparatus system of portable storage container assembly for storing and organizing cooking and Home Food Preservation implements, the storage containers comprising:
a plurality of bases in connection with exterior sidewalls and top rims of the containers, joined by lids and further includes locks, lock latch lower attachments affixed on or in a sidewall or, on or in the top rim, for the connection of a plurality of lock latch upper attachments affixed to the sidewalls, for securing the lids in a locked position by the lock latch lower attachments,
the apparatus further includes a plurality of handles affixed to a plurality of sidewalls, wherein said handles are affixed to the top rims or base of the storage containers or to a plurality of sidewalls by a handle pivot hinge or a plurality of handle pivot hinges on each side of the handle end points, allowing the handle to move in multiple directions,
the apparatus further includes locking mechanisms outer attachments, which may be located on a plurality of sidewalls wherein locking mechanisms inner attachments are connected with the locking mechanisms outer attachments to create locking points for connection and stacking of multiple storage containers, and further includes lock latch upper attachments and lock latch lower attachments for securing the lids in a locked position,
the assembly further includes a plurality of interior sidewalls creating the interior compartments of storage containers wherein contains interior bases, located inside the storage containers which may accommodate, a plurality of permanent or demountable divider guides inside the storage containers for possible location placement of storage compartments for smaller storage containers along with cooking and Home Food Preservation implements which may include but are not limited to; cooking, pressure canning, water bath canning, fermenting, pickling, salting, dehydrating, freezing, vacuum sealing or any other form of cooking and Home Food Preservation method implements.

2. The first storage container, according to claim 1, for storing and organizing multipurpose and miscellaneous cooking and Home Food Preservation implements, the apparatus comprising:
a base connected to a plurality of exterior sidewalls affixed to, a top rim for placement of a lid connected by, a hinge or a plurality of hinges affixed to a top rim, the apparatus further includes a plurality of lock latch lower attachments affixed to a plurality of sidewalls for the connection of a plurality of lock latch upper attachments affixed to the sidewalls, for securing the lid in a locked position by the lock latch lower attachment, the apparatus further includes a handle affixed to the top rim of the storage container by a plurality of handle pivot hinges on each side of the handle end points, allowing the handle to pivot in multiple directions,
the apparatus further includes a locking mechanism outer attachment, which may be located on a singular sidewall or plurality of sidewalls, which may be connected with, a locking mechanism inner attachment, when joined with the locking mechanism outer attachment to create a locking point,
the apparatus further includes a drawer comprising: a base affixed to a plurality of sidewalls, a drawer guide or a plurality of drawer guides, a button lock located on the face of a sidewall for securing the drawer in a closed position when closed,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; a funnels storage compartment, a magnet wands storage compartment, a de-bubbler tools storage compartment, a jar lifters/tong storage compartment, a corn kernel remover tools storage compartment, a jar wrenches storage compartment, a kitchen tongs or miscellaneous cooking and Home Food Preservation implement storage compartment; which may include but are not limited to; disposable metal lids, apple peeler/corers, cherry seed pitting tools, strawberry hullers, tongs, zesters, knives, slicing tools, peelers, freezer bags or miscellaneous implements.

3. The second storage container according to claim 1, for storing and organizing fermenting or miscellaneous cooking and Home Food Preservation implements the apparatus comprising:
a base connected to a plurality of exterior sidewalls affixed to, a top rim for placement of a lid connected by, a hinge or a plurality of hinges affixed to a top rim, the apparatus further includes a plurality of lock latch lower attachments affixed to a plurality of sidewalls for the connection of a plurality of lock latch upper attachments affixed to the sidewalls, for securing the lid in a locked position by the lock latch lower attachment, the apparatus further includes a handle affixed to the top rim of the storage container by a plurality of handle pivot hinges on each side of the handle end points, allowing the handle to pivot in multiple directions,
the apparatus further includes a locking mechanism outer attachment, which may be located on a singular sidewall or plurality of sidewalls, which may be connected with, a locking mechanism inner attachment, when joined with the locking mechanism outer attachment to create a locking point,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; food packers/wooden tamps storage compartment, an oxygen extraction pumps storage compartment, a silicone airlock lids storage compartment, a fermenting springs storage compartment, a fermenting exhaust valves storage compartment, an apple peeler corers/miscellaneous cooking and Home Food Preservation implement storage compartment, which may include but are not limited to; miscellaneous implements, disposable metal lids, apple peeler/corers, cherry seed pitting tools, strawberry hullers, tongs, zesters, knives, slicing tools, peelers, freezer bags.

4. The third storage container, according to claims 3, for storing and organizing fermenting lids or miscellaneous cooking and Homer Food Preservation implements, the apparatus comprising:
a base connected to a plurality of exterior sidewalls affixed to, a top rim for placement of a lid connected by a hinge or a plurality of hinges affixed to a sidewall and the lid,
the apparatus further includes a lock latch lower attachment and a lock latch upper attachment affixed to a plurality of sidewalls for securing the lid in a locked position,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; fermenting lids or miscellaneous implements.

5. The fourth storage container according to claims 3, for storing and organizing fermenting glass/ceramic weights/pebbles or miscellaneous cooking and Home Food Preservation implements, the apparatus comprising:
a base connected to a plurality of exterior sidewalls affixed to, a top rim for placement of a lid connected by a hinge or a plurality of hinges affixed to a sidewall and the lid,
the apparatus further includes a lock latch lower attachment and a lock latch upper attachment affixed to a plurality of sidewalls for securing the lid in a locked position,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments wherein accommodating, a plurality of foam protectors for storing and protecting fermenting glass/ceramic weights/pebbles or miscellaneous implements.

6. The fifth storage container according to claim 1, for storing and organizing lids or miscellaneous cooking and Home Food Preservation implements, the apparatus comprising: a base connected to a plurality of exterior sidewalls affixed to, a top rim for placement of a lid connected by, a hinge or a plurality of hinges affixed to a top rim, the apparatus further includes a plurality of lock latch lower attachments affixed to a plurality of sidewalls for the connection of a plurality of lock latch upper attachments affixed to the sidewalls, for securing the lid in a locked position by the lock latch lower attachment, the apparatus further includes a handle affixed to the top rim of the storage container by a plurality of handle pivot hinges on each side of the handle end points, allowing the handle to pivot in multiple directions,
the apparatus further includes a locking mechanism outer attachment, which may be located on a singular sidewall or plurality of sidewalls, which may be connected with, a locking mechanism inner attachment, when joined with the locking mechanism outer attachment to create a locking point,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; various types of lids such as reusable plastic/glass lids or miscellaneous cooking and Home Food Preservation implements.

7. The sixth storage container according to claims 6, for storing and organizing reusable plastic/glass lids or miscellaneous cooking and Home Food Preservation implements, the apparatus comprising:
a base connected to a plurality of exterior sidewalls affixed to, a top rim for placement of a lid connected by a hinge or a plurality of hinges affixed to a sidewall and the lid,
the apparatus further includes a lock latch lower attachment and a lock latch upper attachment affixed to a plurality of sidewalls for securing the lid in a locked position,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; reusable plastic/glass lids or miscellaneous cooking and Home Food Preservation implements.

8. The seventh storage container according to claims 6, for storing and organizing disposable metal lids or miscellaneous cooking and Home Food Preservation implements, the apparatus comprising:
a base connected to a plurality of exterior sidewalls affixed to, a top rim for placement of a lid connected by a hinge or a plurality of hinges affixed to a plurality of sidewalls,
the apparatus further includes a lock latch lower attachment and a lock latch upper attachment affixed to a plurality of sidewalls for securing the lid in a locked position,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; disposable metal lids or miscellaneous cooking and Home Food Preservation implements.

9. The eighth storage container according to claim 1, for storing and organizing canning ring bands or miscellaneous cooking and Home Food Preservation implements, the apparatus comprising:
a base connected to a plurality of exterior sidewalls affixed to, a top rim for placement of a lid connected by a hinge or a plurality of hinges affixed to a top rim,
the apparatus further includes a lock latch lower attachment, affixed to a sidewall for the connection of a lock latch upper attachment affixed to the lid of the storage containers for securing the lid in a locked position,
the apparatus further includes a plurality of interior sidewalls creating the interior compartment of storage containers by connection to an interior base, located inside the storage container which may accommodate the placement of ten storage containers of claim #10 (see FIG. 4K) or miscellaneous cooking and Home Food Preservation implements,
the apparatus further includes an open compartment for jar/mason jar storage container or miscellaneous implements storage container to
accommodate storage for claim #11 (see FIG. 5A), when collapsed,
the apparatus further includes a plurality of cookbooks/instruction manuals storage compartments on exterior sidewalls,
the apparatus further includes an extendable handle affixed to an extendable handle base of the storage container, wherein the handle may extend upward and downward to lock into place by an extendable handle lock, allowing the handle to lock securely,
the apparatus further includes a wheel axle affixed to a plurality of wheels for portable accessibility and transportation.

10. The ninth storage container according to claim 9, for storing and organizing canning ring bands, reusable plastic/glass lids, rubber/silicone gaskets/rings cooking and Home Food Preservation implements, the apparatus comprising:
a base of the lower portion of the storage container connected to a plurality of exterior sidewalls secured thereto the base of the first lid, by a hinge or a plurality of hinges secured to the second lid by a base, connected to a plurality of sidewalls, secured thereto the first lid by a hinge or a plurality of hinges affixed to a sidewall,
the apparatus further includes two lock latch lower attachments and two lock latch upper attachments affixed to a plurality of sidewalls for securing the lids in a locked position,
the apparatus further includes a plurality of interior sidewalls creating the interior compartment of storage containers by connection to an interior base, located inside the storage container which may accommodate a plurality of divider guides inside the storage containers for possible location and placement of, a divider or dividers, permanent or demountable, purposed for creating a singular or plurality of possible storage compartments for cooking and Home Food Preservation implements, which may include but are not limited to; canning ring bands, reusable glass/ceramic lids, rubber/silicone gaskets/rings or miscellaneous implements.

11. The tenth storage container according to claim 9, wherein said storage container for storing and organizing jars/mason jars or miscellaneous cooking and Home Food Preservation implements, the apparatus comprising:
a base frame, a plurality of exterior sidewalls, two of said sidewalls with a plurality of handles/grips, the sidewalls may be permanent or demountable, the demountable sidewalls are inserted into a pivoting/collapsable structural frame, locked into place by a lid frame, locking the pivoting/collapsable structural frame into place, secured thereto by a plurality of corner frame locks, affixing the lid frame into a locked position over the exterior sidewalls,
the apparatus further includes a plurality of lock latch upper attachments for securing the lid in a closed locked position by a plurality of lock latch lower attachments affixed on a plurality of sidewalls and in the top rim,
the apparatus further includes a plurality of pivot hinges located at the corners of the base frame, wherein the pivoting/collapsable structural frame is raised into an upright position or lowered into the base frame; a plurality of base frame locks, lock each pivoting/collapsable structural frame part into the desired position,
the apparatus further includes a plurality of divider guides inside the storage containers for possible location and placement of, a divider or dividers, permanent or demountable, purposed for creating a singular and/or plurality of possible storage compartments for Home Food Preservation implements, which may include but are not limited to; jars/mason jars or miscellaneous cooking and Home Food Preservation implements,
the apparatus further includes the capability of disassembly, wherein all parts of the storage container fit inside the base frame and lid, wherein the exterior sidewalls, dividers are held securely inside the container when lid is locked to the base frame by a plurality of latch lock upper attachments connected to a plurality of lack lock lower attachments.
